(19) United States
(12) Patent Application Publication
(10) Pub. No.: US 2010/0040877 A1
(43) Pub. Date: Feb. 18, 2010

(54) METHOD FOR LONGITUDINALLY STRETCHING THERMOPLASTIC RESIN FILM AND LONGITUDINALLY STRETCHED FILM PRODUCED BY THE METHOD

(75) Inventors: Tetsuya Yoshida, Fujinomiya-shi (JP); Yoshio Takechi, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Minato-ku, Tokyo (JP)

(21) Appl. No.: 12/440,764

(22) PCT Filed: Sep. 13, 2007
(86) PCT No.: PCT/JP2007/067808

§ 371 Date: Mar. 11, 2009

(30) Foreign Application Priority Data
Sep. 14, 2006 (JP) 2006-249582

(51) Int. Cl. B32B 17/10; B29C 55/18

(52) U.S. Cl. 428/339; 264/175

(57) ABSTRACT

The invention provides a method for longitudinally stretching a thermoplastic resin film, by which a wrinkle or a scratch is not formed during longitudinally stretching a thermoplastic resin film and the retardation at a desired level can be developed, as well as a longitudinally stretched film produced by the method.

A thermoplastic resin film is drawn with a pair of rolls (34a and 36a) rotating at different circumferential velocities to stretch the film longitudinally, thereby a temperature inside a heating oven (32) installed between the pair of rolls (34a and 36a) is set between Tg of the thermoplastic resin film (12)+50° C. and Tg+140° C., and the thermoplastic resin film (12) is stretched in the heating oven (32) over a heating time of 1 sec or longer and 100 sec or shorter.

### TECHNICAL FIELD

The present invention relates to a method for longitudinally stretching a thermoplastic resin film and a longitudinally stretched film produced by the method, especially to a method for longitudinally stretching a thermoplastic resin film to be directed to an optical use such as a liquid crystal display device, and a longitudinally stretched film produced by the method.

### BACKGROUND ART

A process for producing a thermoplastic resin film is largely classified into a solution-casting film formation process and a melt-extrusion film formation process. By a solution-casting film formation process, a dope prepared by dissolving a thermoplastic resin in a solvent is cast from a die onto a support such as a chill drum into a film form. By a melt-extrusion film formation process, a thermoplastic resin is molten in an extruder and extruded from a die onto a support such as a chill drum into a film form. The thermoplastic resin film formed by these methods is stretched in general in a machine (longitudinal) direction and in a cross-machine (transverse) direction to generate in-plane retardation (Re) and thickness-direction retardation (Rth), which is used as a retardation film for a liquid crystal display element in order to enlarge the viewing angle (see: e.g. Patent Document 1 and Patent Document 2).

### Patent Document 1: Japanese National Publication of International Patent Application No. 1994-501040

### Patent Document 2: Japanese Patent Application Laid-Open No. 2001-42130

### DISCLOSURE OF THE INVENTION

### Problems to be Solved by the Invention

There have been problems, in regulating the stretching ratio during longitudinal stretching in order to generate the retardation at a desired level in each of the solution-casting film formation process and the melt-extrusion film formation process, that a wrinkle or a scratch may be formed on a film surface, or the retardation be not favorably generated.

Under such circumstances, the present invention has been made with an object to provide a method for longitudinally stretching a thermoplastic resin film, by which a wrinkle or a scratch is not formed during longitudinally stretching a thermoplastic resin film and the retardation at a desired level can be developed, and a longitudinally stretched film produced by the method.

### Means for Solving the Problems

In order to accomplish the object, the first aspect of the present invention is a method for longitudinally stretching a thermoplastic resin film by drawing the thermoplastic resin film with a pair of rolls rotating at different circumferential velocities, the method comprising: setting a temperature inside a heating oven installed between the pair of rolls at Tg of the thermoplastic resin film+50° C. or higher and Tg+140° C. or lower; and stretching the thermoplastic resin film in the heating oven over a heating time of 1 sec or longer and 100 sec or shorter.

Conventionally, the longitudinal stretching is carried out by heating a film by a local heater and drawing longitudinally the film in a moment (usually about 0.5 sec) by a circumferential velocity difference between a pair of rolls to generate retardation. After strenuous study addressing the problems, the present inventors have found that, if a film is drawn in a moment, the generation of the retardation is difficult to be regulated, and the film becomes susceptible to a scratch due to friction with the rolls. The inventors have further found that the generating retardation can be precisely regulated without forming a defect by stretching the thermoplastic resin film under a heated condition gradually over a defined time period.

Consequently, the present inventors have decided to set the temperature inside a heating oven at Tg of the thermoplastic resin film+50° C. or higher and Tg+140° C. or lower, and to stretch gradually the thermoplastic resin film in the heating oven over a heating time of 1 sec or more and 100 sec or less.

According to the first aspect of the invention, since the temperature inside the heating oven installed between the pair of rolls is set at Tg of the thermoplastic resin film+50° C. or higher and Tg+140° C. or lower, and the thermoplastic resin film is stretched in the heating oven over a heating time of 1 sec or longer and 100 sec or shorter, the stretched film can be free from a wrinkle or a scratch and the retardation thereof can be regulated to a desired level. The stretching is carried out preferably over the heating time of 1 sec or longer and 100 sec or shorter, more preferably 15 sec or longer and 90 sec or shorter, and more preferably 30 sec or longer and 60 sec or shorter. The invention is applicable to a thermoplastic resin film produced by each of a solution-casting film formation process and a melt-extrusion film formation process.

The second aspect of the present invention is, in the first aspect of the invention, the distance between the rolls is 1 m or more and 100 m or less.

According to the second aspect of the invention, a span distance between the rolls is so long as 1 m or more and 100 m or less, that the film between the rolls can be heated uniformly and the stretching ratio can be easily regulated to obtain the aimed retardation.

The third aspect of the present invention is, in the first or second aspect of the invention, a stress of the thermoplastic resin film between the rolls is set in a range from 0.4 MPa or more to 8 MPa or less.

According to the third aspect of the invention, the regulation of the stretching ratio becomes easy by setting the stress of the thermoplastic resin film between the rolls in a range from 0.4 MPa or more to 8 MPa or less. In case the stress is below 0.4 MPa, the film may sag, and in case more than 8 MPa, the film is drawn too tight, so that a wrinkle may be easily formed on the longitudinally stretched film.

The fourth aspect of the present invention is, in any one of the first to the third aspects of the invention, conveying rolls are not installed inside the heating oven.

According to the fourth aspect of the invention, since there are no conveying rolls provided in the heating oven, a scratch, which would be formed with existence of the conveying rolls supporting the film in the heating oven, can be prevented.

The fifth aspect of the present invention is, in the fourth aspect of the invention, the thermoplastic resin film is floated and conveyed in the heating oven.

According to the fifth aspect of the invention, since the thermoplastic resin film is floated and conveyed in the heating oven, a stretching action by the own weight of the film can be avoided and the regulation of the stretching ratio can be made easier, so that aimed retardation can be realized.

The sixth aspect of the present invention is, in the fifth aspect of the invention, the flotation is carried out by an air pressure blown out of nozzles provided above and beneath the thermoplastic resin film.

According to the sixth aspect of the invention, the thermoplastic resin film can be favorably floated and conveyed owing to the air pressure blown out of nozzles provided above and beneath the thermoplastic resin film.

The seventh aspect of the present invention is, in the sixth aspect of the invention, the flotation height is within 30 mm.

According to the seventh aspect of the invention, since the film is prevented from sagging under a blow pressure by limiting the flotation height within 30 mm, the regulation of the stretching ratio can be easily conducted.

The eighth aspect of the present invention is, in any one of the first to the seventh aspects, the longitudinal stretching ratio of the film is more than 1.0 and 2.0 or less.

According to the eighth aspect of the invention, when the present invention has the longitudinal stretching ratio more than 1.0 and 2.0 or less, the stretching ratio of the film can be favorably regulated, the film can be free from a wrinkle or a scratch, and the retardation thereof can be regulated to a desired level.

The ninth aspect of the present invention is a longitudinally stretched film characterized by being produced according to the method for longitudinally stretching a thermoplastic resin film according to any one of the first to the eighth aspects.

The film produced according to the method of longitudinal stretching of the present invention has excellent surface properties and optical properties and therefore suitable for an optical use.

The tenth aspect of the present invention is, in the ninth aspect of the invention, the thermoplastic resin is a cellulose acylate resin.

The present invention is particularly effective, in the event that the thermoplastic resin is a cellulose acylate resin, which is frequently used for an optical use.

### ADVANTAGES OF THE INVENTION

According to the present invention, a thermoplastic resin film can be longitudinally stretched avoiding a wrinkle or a scratch, and generating the retardation at a desired level. Therefore, the longitudinally stretched film produced according to the present invention has excellent surface properties and optical properties, and can be used favorably as a film for an optical use.

### BRIEF DESCRIPTION OF THE DRAWING

FIG. 1 is a structural diagram of film producing equipment according to the present invention;

FIG. 2 is a schematic diagram showing the constitution of an extruder;

FIG. 3 is a structural diagram showing a longitudinally stretching process section of the present invention; and

FIG. 4 is an explanatory table concerning the Examples of the present invention.

### DESCRIPTION OF SYMBOLS

10 . . . film producing equipment, 12 . . . cellulose acylate film, 12′ . . . longitudinally stretched cellulose acylate film, 12″ . . . longitudinally and transversely stretched cellulose acylate film, 14 . . . extruder, 16 . . . die, 18 . . . (chill) drum, 20 . . . film formation process section, 30 . . . longitudinally stretching process section, 32 . . . heating oven, 34, 34a . . . low velocity roll, 36, 36a . . . high velocity roll, 38, 39 . . . nozzles, 40 . . . transversely stretching process section, and 50 . . . winding process section

### BEST MODE FOR CARRYING OUT THE INVENTION

Preferable embodiments of a method for longitudinally stretching a cellulose acylate resin film will be explained by means of the attached drawings. Although production of a cellulose acylate resin film according to a melt-extrusion film formation process is exemplified in this embodiment, the present invention is not limited thereto and a cellulose acylate resin film may be produced according to a solution-casting film formation process. Furthermore, the present invention is applicable to production of a longitudinally stretched film by longitudinally stretching a thermoplastic resin film, such as a polycarbonate resin film and a saturated norbornene resin film.

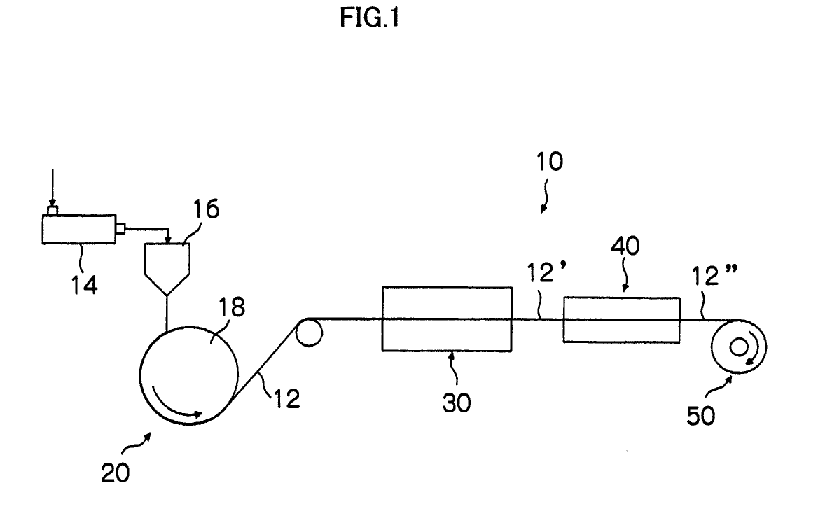

FIG. 1 illustrates an example of an outline constitution of a producing equipment for a cellulose acylate film, in which a longitudinally and transversely stretched cellulose acylate film is produced using a melt-extrusion film formation process.

As shown in FIG. 1, the film producing equipment 10 is composed mainly of a film formation process section 20, in which an unstretched cellulose acylate film 12 is produced, a longitudinally stretching process section 30, in which the cellulose acylate film 12 produced in the film formation process section 20 is stretched longitudinally, a transversely stretching process section 40, in which the longitudinally stretched film 12′ is stretched transversely, and a winding process section 50, in which the longitudinally and transversely stretched cellulose acylate film 12″ is wound to a reel. Although this embodiment is illustrated with the longitudinally stretching process section 30 incorporated in a process of the film producing equipment 10, a film once wound-up in the winding process section 50 may be longitudinally stretched in a separate longitudinally stretching line.

In the film formation process section 20, a cellulose acylate resin molten in the extruder 14 is extruded through the die 16 in a sheet form, and cast onto the rotating drum 18. The molten resin is chilled and solidified on the surface of the drum 18 to obtain the cellulose acylate film 12. The cellulose acylate film 12 is released from the drum 18 and sent to the longitudinally stretching process section 30 and to the transversely stretching process section 40 sequentially to be stretched, and then to the winding process section 50 to be wound and a reel. Thus the production of a longitudinally and transversely stretched cellulose acylate film 12″ is complete.

Details of the respective process sections will be described below.

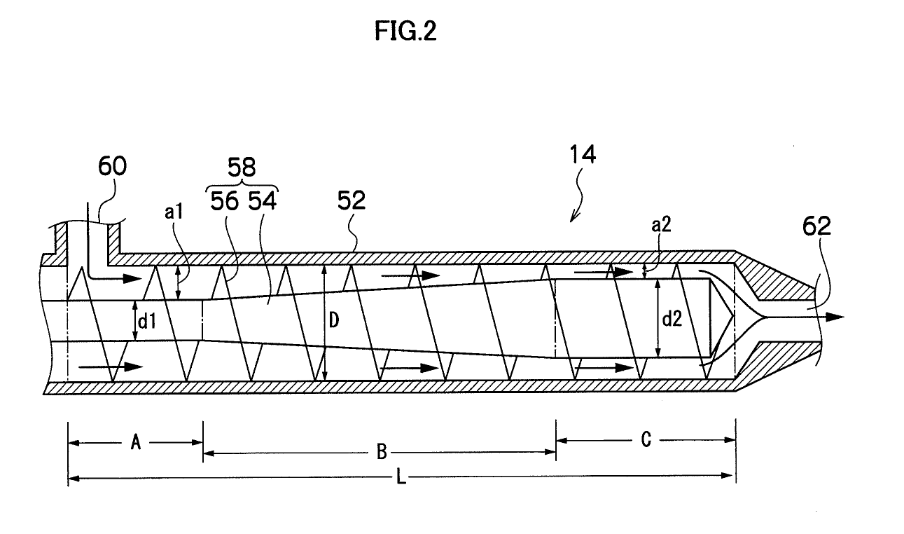

FIG. 2 shows the constitution of an extruder 14 in the film formation process section 20. As shown in the figure, in a cylinder 52 of the extruder 14 a single screw 58 having a screw shaft 54 with a flight 56 is installed, and the single screw 58 is rotated by a motor (not illustrated).

A hopper (not illustrated) is connected to a feeding port 60 of the cylinder 52, and a cellulose acylate resin is fed from the hopper through the feeding port 60 into the cylinder 52.

In the cylinder 52 are arranged a feed zone (zone denoted as A), where the cellulose acylate resin fed from the feeding port 60 is transported constantly, a compression zone (zone denoted as B), where the cellulose acylate resin is kneaded and compressed, and a metering zone (zone denoted as C), where the kneaded and compressed cellulose acylate resin is metered, from the feeding port 60 side in the mentioned order. The cellulose acylate resin molten in the extruder 14 is sent continuously through a discharge port 62 to the die 16.

The screw compression ratio of the extruder 14 is set at 2.5 to 4.5, and the L/D is set at 20 to 70. Thereby the screw compression ratio represents a volume ratio of the feed zone A to the metering zone C, namely represents the quotient of (a volume of the feed zone A per unit length) by (a volume of the metering zone C per unit length) and is calculated using the outer diameter d1 of the screw shaft 34 in the feed zone A, the outer diameter d2 of the screw shaft 34 in the metering zone C, the channel depth a1 in the feed zone A, and the channel depth a2 in the metering zone C. Further, L/D represents the ratio of the cylinder inner diameter (D) to the cylinder length (L) in FIG. 2. The extruding temperature is set at 190 to 240° C. If the temperature in the extruder 14 exceeds 240° C., it is preferable to install a cooler (not illustrated) between the extruder 14 and the die 16.

The extruder 14 may be a single screw extruder as well as a twin screw extruder, however, if the screw compression ratio is so small as below 2.5, kneading becomes insufficient which may lead to generation of unmolten solids, to insufficient generation of the shearing heat to cause insufficient melting of crystals, leaving minute crystallites in the produced cellulose acylate film, and further to vulnerability to bubble mixing. In such event, when a cellulose acylate film 12 is stretched, the remaining crystallites would deteriorate stretchability leading to poor orientation. On the contrary, if the screw compression ratio is so large as above 4.5, heat generation by too high shearing force could lead to possible deterioration of the resin and yellowish discoloration of the produced cellulose acylate film. Further too high shearing stress could cause molecular scission lowering the molecular weight and the mechanical strength of the film. Consequently to prevent yellowish discoloration of the produced cellulose acylate film and breakage during stretching, the screw compression ratio is preferably in a range of 2.5 to 4.5, more preferably in a range of 2.8 to 4.2, and further preferably in a range of 3.0 to 4.0.

If L/D is so small as below 20, insufficient melting or insufficient kneading can take place, and as in the case of too small compression ratio, minute crystallites tend to remain in a produced cellulose acylate film. Reversely, if L/D is so large as more than 70, the residence time of the cellulose acylate resin in the extruder 14 becomes too long, and the resin becomes vulnerable to deterioration. The longer residence time leads to molecular scission to lower the molecular weight and mechanical strength of the film. Consequently to prevent yellowish discoloration of the produced cellulose acylate film and breakage during stretching, the L/D is preferably in a range of 20 to 70, more preferably in a range of 22 to 45, and further preferably in a range of 24 to 40.

If the extruding temperature is so low as below 190° C., insufficient melting of crystals may be caused, which apt to remain in the produced cellulose acylate film as minute crystallites, which deteriorate stretchability leading to poor orientation, when the cellulose acylate film is stretched. Reversely, if the extruding temperature is so high as more than 240° C., the cellulose acylate resin may be deteriorated and the yellow index (YI value) becomes poorer. Consequently to prevent yellowish discoloration of the produced cellulose acylate film and breakage during stretching, the extrusion temperature is preferably 190° C. to 240° C., more preferably in a range of 195° C. to 235° C., and further preferably in a range of 200° C. to 230° C.

The molten resin is continuously fed to the die 16 in FIG. 1. The fed molten resin is extruded in a sheet form through the lips (lower edge) of the die 16 and the extruded molten resin is cast onto the drum 18, chilled to solidify on the surface of the drum 18, and released therefrom to complete the production of the cellulose acylate film 12.

The cellulose acylate film 12 produced in the film formation process section 20 is sent sequentially to the longitudinally stretching process section 30 and to the transversely stretching process section 40.

The longitudinally stretching method according to the present invention, by which the cellulose acylate film 12 produced in the film formation process section 20 is longitudinally stretched to produce a longitudinally stretched cellulose acylate film 12′, will be explained below.

The cellulose acylate film 12 is stretched in order to orient molecules in the cellulose acylate film 12 for generating the in-plane retardation (Re) and the thickness-direction retardation (Rth). Thereby the retardations Re, Rth can be calculated by the following formulas.

Re(nm)=|n(MD)−n(TD)|×T(nm)

Rth(nm)=|{(n(MD)+n(TD))/2}−n(TH)|×T(nm)

where n(MD), n(TD), and n(TH) represent the refractive indices in the longitudinal direction, transverse direction and thickness direction respectively, and T represents the thickness expressed in the unit of nm.

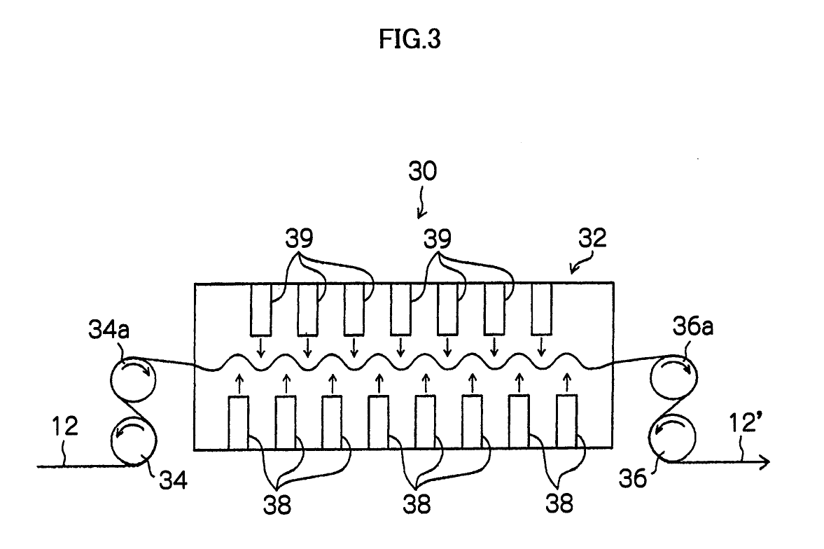

As shown in FIG. 1, the cellulose acylate film 12 is stretched first in the longitudinal direction in the longitudinally stretching process section 30. As shown in FIG. 3 in the longitudinally stretching process section 30, the cellulose acylate film 12 is longitudinally stretched by the circumferential velocity difference between the low velocity rolls 34, 34a and the high velocity rolls 36, 36a. The low velocity rolls 34, 34a are heated, and the roll surface temperature is in general set at 50 to 150° C. While the high velocity rolls 36, 36a are cooled, and the roll surface temperature is in general set at 10 to 50° C.

As shown in FIG. 3, when longitudinally stretched, the cellulose acylate film 12 is heated in a heating oven 32, which is installed between the rolls 34a and 36a rotating at different circumferential velocities and set in a range from Tg+50° C. or higher to Tg+140° C. or lower, for a time period in a range from 1 sec or longer and 100 sec or shorter.

Thus, the retardation is generated by heating the cellulose acylate film 12 and longitudinally drawing the cellulose acylate film 12 by the circumferential velocity difference between the rolls 34a and 36a. By setting heating temperature in a range from Tg+50° C. or higher to Tg+140° C. or lower and by heating for a long time period ranging from 1 sec or longer to 100 sec or shorter in the heating oven 32, favorable longitudinal stretching is realized. In other word, owing to such long time heating a wrinkle or a scuff mark can be prevented and the stretching ratio can be easily regulated, so that the desired level of the retardation can be attained.

Furthermore, the distance between the rolls 34a and 36a should preferably be 1 m or more and 100 m or less. Owing to such a long span of 1 m or more and 100 m or less, the film between the rolls can be uniformly heated, and the stretching ratio can be easily regulated. Therefore, the aimed level of the retardation can be obtained.

Further, the stress of the cellulose acylate film 12 between the rolls 34a and 36a should preferably be set in a range from 0.4 MPa or more to 8 MPa or less. By limiting the stress on the cellulose acylate film 12 to the range from 0.4 MPa or more to 8 MPa or less, the stretching ratio can be easily regulated. In case it is below 0.4 MPa the film will sag, and in case it is more than 8 MPa the film will be drawn too tightly, and thus a longitudinally stretched film will be apt to develop a wrinkle.

It is preferable as shown in FIG. 3, that conveying rolls be not installed in the heating oven 32. By eliminating the conveying rolls in the heating oven, a scratch on the film surface can be prevented, which would be formed if the conveying rolls are installed in the heating oven. It is preferable that the cellulose acylate film 12 be floated for being conveyed inside the heating oven. By floating the cellulose acylate film for conveying inside the heating oven, a stretching action by the own weight of the film can be avoided and the regulation of the stretching ratio can be made easier. This enables to obtain aimed retardation. It is further preferable to use a flotation method that the cellulose acylate film 12 be supported by an air pressure blown out of the nozzles 39, 39 . . . located above the film and the nozzles 38, 38 . . . located beneath the film. By the air pressure blown out of the nozzles located above and beneath the cellulose acylate film 12, the same can be favorably floated and conveyed.

By blowing air onto the top surface of the cellulose acylate film 12 from the nozzles 39, 39 . . . located above the film, its floating-up can be prevented, and the flotation height can be controlled within 30 mm by such air suppression on the top surface of the film. Through controlling the flotation height within 30 mm, sagging of the film by the blown pressure can be prevented and the regulation of the stretching ratio becomes easy.

For stretching longitudinally as above, the longitudinal stretching ratio is preferably more than 1.0 and 2.0 or less. If the longitudinal stretching ratio is more than 1.0 and 2.0 or less, the longitudinal stretching ratio can be regulated well, a wrinkle or a scratch on the stretched film can be prevented, and a desired level of the retardation of the film can be attained.

As a result, in the longitudinally stretching process section 30, the cellulose acylate film is heated in a heating oven, which is installed between the rolls rotating at different circumferential velocities and set in a range from Tg+50° C. or higher to Tg+140° C. or lower, for a time period in a range from 1 sec or longer to 100 sec or shorter, and therefore the stretched film is free from a wrinkle or a scratch, and a desired level of the retardation of the film is attained. Although the case where the cellulose acylate film is produced by a melt-extrusion film formation process is described above, the method for longitudinally stretching a thermoplastic resin film according to the present invention is applicable to a thermoplastic resin film produced by either a melt-extrusion film formation process or a solution-casting film formation process.

The longitudinally stretched cellulose acylate film 12′ is sent to the transversely stretching process section 40 and stretched transversely (in the cross-machine direction). In the transversely stretching process section 40, for example, a tenter can be favorably used, which grips both the cross-machine direction sides of the cellulose acylate film 12′ using clips and stretches the same transversely (in the cross-machine direction). By this transverse stretching, the retardation Rth can be further increased.

Through the longitudinal and transverse stretching treatments as described above, a longitudinally and transversely stretched cellulose acylate 12″ generating the retardation Re and Rth is obtained. Of the longitudinally and transversely stretched cellulose acylate film 12″, Re is 0 nm or more and 500 nm or less, more preferably 10 nm or more and 400 nm or less, and further preferably 15 nm or more and 300 nm or less, and Rth is −100 nm or more and 100 nm or less, more preferably −50 nm or more and 50 nm or less, and further preferably −30 nm or more and 30 nm or less. Among them, the film should more preferably satisfy Re≧|Rth|, and further preferably satisfy Re≧|Rth|×2. Further, it is preferable to limit the fluctuation of Re and Rth by location in the cross-machine direction and in the machine direction respectively within 5%, more preferably within 4%, and further preferably within 3%. Furthermore, the orientation angle should be preferably within 90°±5° or 0°±5°, more preferably within 90°±3° or 0°±30, and further preferably within 90°±11 or 0°±10. By carrying out the stretching treatments according to the present invention, the bowing of the stretched film can be mitigated. The bowing distortion is defined as a ratio of a displacement of a line at the center to the width, the line being drawn on the surface of the cellulose acylate film 12 along the cross-machine direction before entering into the tenter, and being deformed to be a bow curve after the stretching. The bowing ratio is preferably 10% or less, more preferably 5% or less, and further preferably 3% or less.

Details of the cellulose acylate resins suitable for the present invention and processing methods of the cellulose acylate film will be explained stepwise.

(1) Plasticizer

It is preferable to add a polyhydric alcohol-type plasticizer to a source resin for producing a cellulose acylate film according to the present invention. Such plasticized works not only to decrease the elastic modulus, but also to mitigate the difference in crystallinities at the top and bottom side of the film.

The content of the polyhydric alcohol-type plasticizer is preferably 2 to 20 weight-% with respect to the cellulose acylate, more preferably 3 to 18 weight-%, and further preferably 4 to 15 weight-%.

In case the content of the polyhydric alcohol-type plasticizer is less than 2 weight-%, the above-mentioned activity cannot be obtained sufficiently, and in case it is more than 20 weight-% bleeding (precipitation of a plasticizer at the surface) occurs. Specific examples of a plasticizer to be used for the present invention, having good compatibility with cellulose fatty acid ester and expressing good plasticizing activity, include: an ester compound with glycerin, such as a glycerin ester and a diglycerin ester, a polyalkylene glycol, such as polyethylene glycol and polypropylene glycol, and a compound of polyalkylene glycol whose hydroxy group is bonded with an acyl group.

Specific examples of a glycerin ester include, but not limited to, glycerin diacetate stearate, glycerin diacetate palmitate, glycerin diacetate mystirate, glycerin diacetate laurate, glycerin diacetate caproate, glycerin diacetate nonanoate, glycerin diacetate octanoate, glycerin diacetate heptanoate, glycerin diacetate hexanoate, glycerin diacetate pentanoate, glycerin diacetate oleate, glycerin acetate dicaproate, glycerin acetate dinonanoate, glycerin acetate dioctanoate, glycerin acetate diheptanoate, glycerin acetate dicaproate, glycerin acetate divalerate, glycerin acetate dibutyrate, glycerin dipropionate caproate, glycerin dipropionate laurate, glycerin dipropionate mystirate, glycerin dipropionate palmitate, glycerin dipropionate stearate, glycerin dipropionate oleate, glycerin tributyrate, glycerin tripentanoate, glycerin monopalmitate, glycerin monostearate, glycerine distearate, glycerin propionate laurate and glycerin oleate propionate. The above may be used singly or in combination.

Among these are preferable glycerin diacetate caprylate, glycerin diacetate pelargonate, glycerin diacetate caproate, glycerin diacetate laurate, glycerin diacetate myristate, glycerin diacetate palmitate, glycerin diacetate stearate and glycerin diacetate oleate.

Specific examples of a diglycerin ester include, but not limited to, mixed acid esters of diglycerin, such as diglycerin tetraacetate, diglycerin tetrapropionate, diglycerin tetrabutyrate, diglycerin tetravalerate, diglycerin tetrahexanoate, diglycerin tetraheptanoate, diglycerin tetracaprylate, diglycerin tetrapelargonate, diglycerin tetracaproate, diglycerin tetralaurate, diglycerin tetra mystirate, diglycerin tetrapalmitate, diglycerin triacetate propionate, diglycerin triacetate butyrate, diglycerin triacetate valerate, diglycerin triacetate hexanoate, diglycerin triacetate heptanoate, diglycerin triacetate caprylate, diglycerin triacetate pelargonate, diglycerin triacetate caproate, diglycerin triacetate laurate, diglycerin triacetate mystirate, diglycerin triacetate palmitate, diglycerin triacetate stearate, diglycerin triacetate oleate, diglycerin diacetate dipropionate, diglycerin diacetate dibutyrate, diglycerin diacetate divalerate, diglycerin diacetate dihexanoate, diglycerin diacetate diheptanoate, diglycerin diacetate dicaprylate, diglycerin diacetate dipelargonate, diglycerin diacetate dicaproate, diglycerin diacetate dilaurate, diglycerin diacetate dimystirate, diglycerin diacetate dipalmitate, diglycerin diacetate distearate, diglycerin diacetate dioleate, diglycerin acetate tripropionate, diglycerin acetate tributyrate, diglycerin acetate trivalerate, diglycerin acetate trihexanoate, diglycerin acetate triheptanoate, diglycerin acetate tricaprylate, diglycerin acetate tripelargonate, diglycerin acetate tricaproate, diglycerin acetate trilaurate, diglycerin acetate trimystirate, diglycerin acetate tripalmitate, diglycerin acetate tristearate, diglycerin acetate trioleate, diglycerin laurate, diglycerin stearate, diglycerin caprylate, diglycerin myristate and diglycerin oleate. The above may be used singly or in combination. Among these are preferable diglycerin tetraacetate, diglycerin tetrapropionate, diglycerin tetrabutyrate, diglycerin tetracaprylate and diglycerin tetralaurate.

Specific examples of polyalkylene glycol include, but not limited to, polyethylene glycol and polypropylene glycol having an average molecular weight of 200 to 1,000, which may be used singly or in combination.

Specific examples of a compound of polyalkylene glycol whose hydroxy group is bonded with an acyl group include, but not limited to, polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanoate, polyoxyethylene caproate, polyoxyethylene laurate, polyoxyethylene myristate, polyoxyethylene palmitate, polyoxyethylene stearate, polyoxyethylene oleate, polyoxyethylene linoleate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanoate, polyoxypropylene caproate, polyoxypropylene laurate, polyoxypropylene myristate, polyoxypropylene palmitate, polyoxypropylene stearate, polyoxypropylene oleate and polyoxypropylene linoleate. The above may be used singly or in combination.

Furthermore in order to fully express the activity of these polyhydric alcohols, it is preferable to form a cellulose acylate into a film by melt-extrusion film formation under the following conditions. That is, when pellets of a mixture of a cellulose acylate and a polyhydric alcohol are molten in an extruder and extruded through the T-die to form a film, it is preferable to keep the extruder temperature at the outlet (T2) higher than the extruder temperature at the inlet (T1), and further preferably to keep the die temperature (T3) higher than T2. In other words, the temperature should preferably rise in parallel with advancement of melting. If the temperature is elevated too rapidly at the inlet, the polyhydric alcohol first melts to a liquid. The cellulose acylate floats in the liquid and unable to receive sufficiently the shearing force of the screw, leaving non-molten parts. In such a heterogeneous blend the plasticizer cannot express the activity as described above, and the effect of suppressing the difference between the top and bottom surface of the extruded molten film cannot be obtained. Further, the insufficiently molten materials appear as foreign matters like fisheyes after film formation. Such foreign matters are not to be identified as bright points under observation with a polarizer, rather recognizable visually on the screen when light is projected from the backside of the film. Further, the fisheye causes tailing at the die outlet and increases also die lines.

The T1 is preferably 150 to 200° C., more preferably 160 to 195° C., and further preferably 165° C. or higher and 190° C. or lower. The T2 is preferably in a range of 190 to 240° C., more preferably 200 to 230° C., and further preferably 200 to 225° C. It is crucial that the melt temperatures of T1 and T2 should not exceed 240° C. Beyond that temperature, the elastic modulus of the formed film tends to rise. This rise of the elastic modulus is probably attributable to cross-linking caused by degradation of cellulose acylate due to melting at a high temperature. The die temperature T3 is preferably 200 to 235° C., more preferably 205 to 230° C., and further preferably 205° C. or higher and 225° C. or lower.

(2) Stabilizer

For the present invention, either or both of a phosphite type compound and a phosphorous acid ester type compound are preferably used as a stabilizer. They inhibits aging, and additionally improves die lines, because the compound works as a leveling agent, which diminishes die lines caused by unevenness of the die.

The blended content of the stabilizer is preferably 0.005 to 0.5 weight-%, more preferably 0.01 to 0.4 weight-%, and further preferably 0.02 to 0.3 weight-%.

(i) Phosphite Type Stabilizer

Although there is no restriction on a specific phosphite type color stabilizer, such phosphite type color stabilizers as represented by the chemical formulas 1 to 3 are preferable.

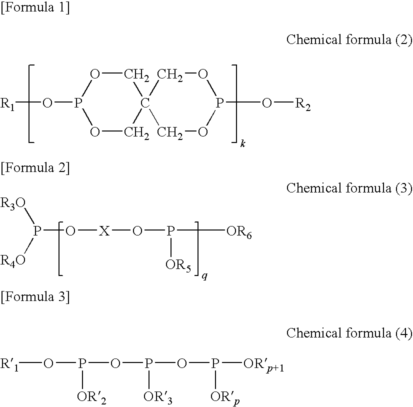

wherein R1, R2, R3, R4, R5, R6, R′1, R′2, R′³ . . . R′n and R′n+1 represent a hydrogen atom or a group selected from the set consisting of alkyl, aryl, alkoxyalkyl, aryloxyalkyl, alkoxyaryl, arylalkyl, alkylaryl, polyaryloxyalkyl, polyalkoxyalkyl and polyalkoxyaryl groups having a carbon number from 4 to 23, provided that not all of them existing in any one of the chemical formulas (2), (3) and (4) are simultaneously hydrogen atoms. The X in a phosphite type color stabilizer represented by the chemical formula (3) represents a group selected from the set consisting of an aliphatic chain, an aliphatic chain having an aromatic nucleus as a side chain, an aliphatic chain having an aromatic nucleus in the chain, and a chain having two or more oxygen atoms existing not consecutively in any of the above-listed chains. The k and q represent an integer of 1 or higher, and the p represents an integer of 3 or higher.

The number of k and q of the phosphite type color stabilizer are preferably 1 to 10. In case k and q are 1 or higher, the volatility at heating becomes low. In case they are 10 or lower, the compatibility with cellulose acetate propionate is favorably increased. The value of p is preferable 3 to 10. In case p is 3 or higher the volatility at heating becomes low. In case p is 10 or lower, the compatibility with cellulose acetate propionate is favorably increased.

As specific examples of the phosphite type color stabilizer represented by the following chemical formula (2), those represented by the chemical formulas (5) to (8) are preferable.

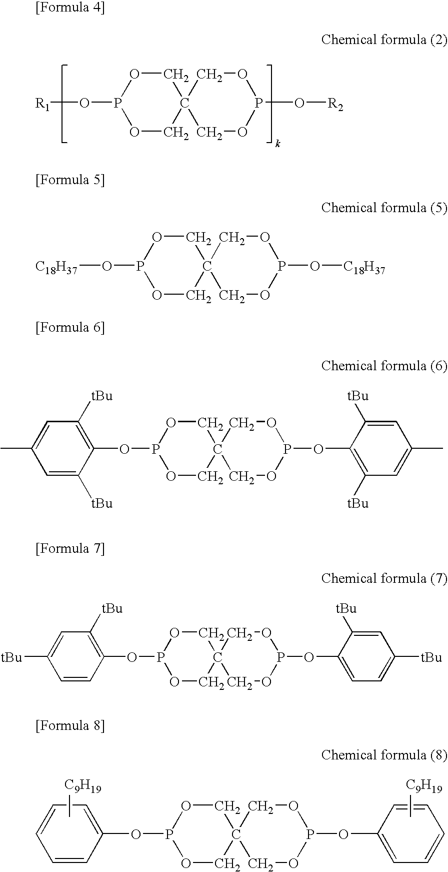

As specific examples of the phosphite type color stabilizer represented by the following chemical formula (3), those represented by the following chemical formulas (9), (10) and (11) are preferable.

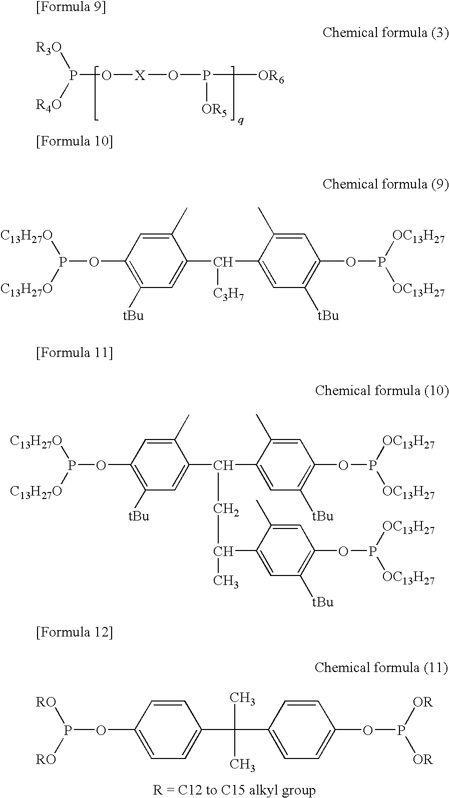

(ii) Phosphorous Acid Ester Type Stabilizer

Examples of a phosphorous acid ester type stabilizer include cyclic neopentanetetraylbis(octadecyl)phosphite, cyclic neopentanetetraylbis(2,4-di-t-butylphenyl)phosphite, cyclic neopentanetetraylbis(2,6-di-t-butyl-4-methylphenyl)phosphite, 2,2-methylenebis(4,6-di-t-butylphenyl)octylphosphite, and tris(2,4-di-butylphenyl)phosphite.

(iii) Other Stabilizers

A weak organic acid, a thioether compound or an epoxy compound may be blended as a stabilizer.

A week organic acid is a compound having pKa of 1 or higher. There is no restriction on selection insofar as it does not interfere with the activity according to the present invention and has anti-discoloration activity and anti-aging activity. Examples include tartaric acid, citric acid, malic acid, fumaric acid, oxalic acid, succinic acid, and maleic acid. They may be used singly or in combination of two or more.

Examples of a thioether compound include dilaurylthiodipropionate, ditridecylthiodipropionate, dimyristylthiodipropionate, distearylthiodipropionate and palmitylstearylthiodipropionate. They may be used singly or in combination of two or more.

Examples of an epoxy compound include a derived of epichlorohydrin and bisphenol A, a derivative of epichlorohydrin and glycerin and a cyclic compound, such as vinylcyclohexene dioxide and 3,4-epoxy-6-methylcyclohexylmethyl-3,4-epoxy-6-methylcyclohexane carboxylate. Furthermore, an epoxidized soybean oil, an epoxidized castor oil, and long chain-α-olefin oxides may be used. They may be used singly or in combination of two or more.

(3) Cellulose Acylate

[Cellulose Acylate Resin]

(Composition/substitution Degree)

A cellulose acylate satisfying all the requirements represented by the following formulas (1) to (3) is preferable as the cellulose acylate to be used in the present invention.

2.0≦X+Y≦3.0 Formula (1)

0≦X≦2.0 Formula (2)

1.0≦Y≦2.9 Formula (3)

(In the formulas (1) to (3), X represents a substitution degree of an acetate group, Y represents the sum of the substitution degrees of a propionate group, a butyrate group, a pentanoyl group and a hexanoyl group.)

more preferably,

2.4≦X+Y≦3.0 Formula (4)

0.05≦X≦1.8 Formula (5)

1.3≦Y≦2.9 Formula (6)

further preferably,

2.5≦X+Y≦2.95 Formula (7)

0.1≦X≦1.6 Formula (8)

1.4≦Y≦2.9 Formula (9)

Thus, the embodiment has a characteristic that propionate group, a butyrate group, a pentanoyl group and a hexanoyl group are introduced into cellulose acylate when a cellulose acylate is produced. By fulfilling the above ranges, the melting temperature can be lowered and thermolysis associated with melt-extrusion film formation can be favorably suppressed. While, outside the above described ranges, the modulus of elasticity falls outside the scope of the present invention, and is not preferable.

Such cellulose acylates may be used singly or in combination of two or more types. A polymer component other than a cellulose acylate may be blended appropriately.

Next, a method for producing the cellulose acylate of the present invention will be explained in more details. A source cotton and a synthetic method for the cellulose acylate of the present invention are also described in details in Journal of Technical Disclosure (Disclosure No. 2001-1745, published on 15 Mar. 2001 by the Japan Institute of Invention and Innovation, p. 7 to 12).

(Source Materials and Pretreatment)

Favorably used source cellulose is derived from hard-wood pulp, soft-wood pulp and cotton linter. As source cellulose, a high-purity material containing α-cellulose in a range from 92 mass-% or more to 99.9 mass-% or less is preferably used.

If a source cellulose is in a sheet or bale form, it should be preferably opened up in advance, so that the opening of cellulose has preferably advanced to a fluffy state.

(Activation)

Prior to acylation, it is preferable that the source cellulose is brought into contact with an activating agent (activation treatment). As the activating agent, a carboxylic acid or water may be used. In case water is used, it is preferable to have a treatment step after the activation, such as adding excess of acid anhydride to remove water, or washing the product with a carboxylic acid to replace water, or adjusting the conditions for acylation. An activating agent may be added after adjusted to an appropriate temperature. A method of addition thereof may be selected from spraying, dropping and dipping.

Preferable examples of a carboxylic acid for an activating agent include a carboxylic acid having a carbon number from 2 or more to 7 or less, such as acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentane carboxylic acid, heptanoic acid, cyclohexane carboxylic acid, and benzoic acid; more preferable examples are acetic acid, propionic acid and butyric acid; and a further preferable example is acetic acid.

By activation, if necessary, an acylation catalyst such as sulfuric acid may be further added. However, the amount to be added should preferably be limited to a range of 0.1 mass-% to 10 mass-%, because an added strong acid such as sulfuric acid may accelerate depolymerization. Two or more activating agents may be used in combination, and an anhydride of a carboxylic acid having a carbon number from 2 or more to 7 or less may be added.

The addition amount of an activating agent is preferably 5 mass-% or more with respect to cellulose, more preferably 10 mass-% or more, and further preferably 30 mass-% or more. If the amount of an, activating agent is more than the lower limit, inconvenience such as low degree of activation of cellulose should be favorably prevented. Although there is no upper limit of the addition amount of an activating agent, insofar as the productivity is not reduced; the amount is preferably 100-fold or less by mass for cellulose, more preferably 20-fold or less, and further preferably 10-fold or less. Alternatively, a large excess of an activating agent relative to cellulose is used for activation, and then the amount of the activating agent is decreased by a treatment, such as filtration, aerated drying, heat drying, vacuum evaporation and solvent replacement.

The activation time is preferably 20 min or longer. Although there is no upper limit of the activation time, insofar as the productivity is not reduced; the activation time is preferably 72 hours or less, more preferably 24 hours or less, and further preferably 12 hours or less. The activation temperature is preferably 0° C. or higher and 90° C. or lower, more preferably 15° C. or higher and 80° C. or lower, and further preferably 20° C. or higher and 60° C. or lower. The procedure of the activation of cellulose may be carried out under a high pressure or a reduced pressure. As means for heating, an electromagnetic wave, such as microwave and infrared rays, may be used.

(Acylation)

By a preferable method for producing the cellulose acylate according to the present invention, a carboxylic acid anhydride is admixed with cellulose for reaction using a Bronsted acid or a Lewis acid as a catalyst to acylate hydroxy groups of cellulose.

To obtain a cellulose mixed-acylate, may be used any of: a method of adding simultaneously or successively two types of carboxylic acid anhydrides as acylating agents for reaction with cellulose; a method of using a mixed acid anhydride of two carboxylic acids (e.g., mixed acid anhydride of acetic acid and propionic acid); a method of synthesizing a mixed acid anhydride (e.g., mixed acid anhydride of acetic acid and propionic acid) in a reaction system from a carboxylic acid and an anhydride of a different carboxylic acid (e.g., acetic acid and propionic anhydride) for reaction with cellulose; and a method of once synthesizing a cellulose acylate having the substitution degree of less than 3 followed by additional acylation of the remaining hydroxyl groups with an acid anhydride or an acid halide.

(Acid Anhydride)

A preferable carboxylic acid anhydride has a carbon number from 2 or more to 7 or less in a carboxylic acid segment, and examples thereof include: acetic anhydride, propionic anhydride, butyric anhydride, 2-methylpropionic anhydride, valeric anhydride, 3-methylbutyric anhydride, 2-methylbutyric anhydride, 2,2-dimethylpropionic anhydride (pivalic anhydride), hexanoic anhydride, 2-methylvaleric anhydride, 3-methylvaleric anhydride, 4-methylvaleric anhydride, 2,2-dimethylbutyric anhydride, 2,3-dimethylbutyric anhydride, 3,3-dimethylbutyric anhydride, cyclopentane carboxylic anhydride, heptanoic anhydride, cyclohexane carboxylic anhydride and benzoic anhydride. More preferable examples include acetic anhydride, propionic anhydride, butyric anhydride, valeric anhydride, hexanoic anhydride and heptanoic anhydride; and further preferable examples include acetic anhydride, propionic anhydride and butyric anhydride.

A mixture of the above anhydrides is favorably used for preparing a mixed ester. It is preferable to determine the mixture ratio depending on the substitution degree of the intended mixed ester. The acid anhydride is usually added in an excessive equivalence with respect to cellulose. More specifically, it is preferable to add the same in an amount of 1.2 to 50 equivalents to hydroxy groups of cellulose, more preferably to add 1.5 to 30 equivalents, and further preferably to add 2 to 10 equivalents.

(Catalyst)

It is preferable to use a Bronsted acid or a Lewis acid as an acylation catalyst to be used for producing a cellulose acylate according to the present invention. The definitions of Bronsted acid and Lewis acid are set forth for example in Dictionary of Physics and Chemistry 5th Edition (2000). Examples of a preferable Bronsted acid include sulfuric acid, perchloric acid, phosphoric acid, methanesulfonic acid, benzenesulfonic acid, p-toluenesulfonic acid. Examples of a preferable Lewis acid include zinc chloride, tin chloride, antimony chloride, magnesium chloride.

As the catalyst are sulfuric acid and perchloric acid more preferable, and sulfuric acid is particularly preferable. The preferable addition amount of the catalyst is 0.1 to 30 mass-% with respect to cellulose, more preferable is 1 to 15 mass-%, and further preferable is 3 to 12 mass-%.

(Solvent)

In acylation, a solvent may be used for the purpose of controlling the viscosity, the reaction rate, the stirring capability and the acyl substitution ratio. As the solvent may be used dichloromethane, chloroform, a carboxylic acid, acetone, ethyl methyl ketone, toluene, dimethylsulfoxide and sulfolane. However, favorable is a carboxylic acid, and such carboxylic acid having a carbon number from 2 or more to 7 or less may be exemplified, as acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentanecarboxylic acid. Examples of a more preferable solvent include acetic acid, propionic acid and butyric acid. These solvents may be mixed for use.

(Conditions for Acylation)

In acylation, an acid anhydride, a catalyst and additionally, if necessary, a solvent may be mixed first and then with cellulose; or they may be successively mixed with cellulose. In general, however, it is preferable that a mixture of an acid anhydride and a catalyst, or a mixture of an acid anhydride, a catalyst and a solvent is prepared as an acylating agent, and this is reacted with cellulose. In order to suppress the temperature increase inside the reactor by the reaction heat of acylation, it is preferable to cool previously the acylating agent. The cooling temperature is preferably −50° C. to 20° C., more preferably −35° C. to 10° C., and further preferably −25° C. to 5° C. The acylating agent may be added as a liquid or as a frozen solid in a crystal form, a flake form or a block form.

Further, the acylating agent may be added to cellulose at one time, or divided portions may be added separately. Alternatively, cellulose may be added to the acylating agent at one time, or divided portions may be added separately. When the addition of the acylating agent is conducted divisionally, an acylating agent with the same composition or acylating agents with a plurality of compositions may be used. Preferable examples include: 1) a mixture of an acid anhydride and a solvent is charged first, and then a catalyst is added; 2) a mixture of an acid anhydride and a part of a solvent and a catalyst is charged first, and then a mixture of the remaining catalyst and solvent is added; 3) a mixture of an acid anhydride and a solvent is charged first, and then a mixture of a catalyst and a solvent is added; and 4) a solvent is charged first, and then a mixture of an acid anhydride and a catalyst, or a mixture of an acid anhydride, a catalyst and a solvent is added.

The acylation of cellulose is an exothermic reaction. In the process for producing the cellulose acylate according to the invention, it is preferable to limit the maximum elevated temperature in acylation below 50° C. In case the reaction temperature is below this temperature, inconvenience such as progress of depolymerization, which would make it difficult to obtain the cellulose acylate having a degree of polymerization suitable for the use of the present invention, can be favorably prevented. The maximum elevated temperature in acylation is preferably 45° C. or less, more preferably 40° C. or less, and further preferably 35° C. or less. The reaction temperature may be controlled with a temperature controller or by the initial temperature of the acylating agent. It may also be controlled by reducing the reactor pressure to evaporate a liquid component regulating the temperature by the evaporation heat. Since heat generation is larger at the initial reaction stage of acylation, the reaction may be controlled by cooling at the initial stage and heating at a later stage. The end point of the acylation may be determined by means of light transmittance, solution viscosity, temperature change of the reaction system, solubility of the product in an organic solvent or observation under a polarization microscope.

The minimum reaction temperature is preferably −50° C. or higher, more preferably −30° C. or higher, and further preferably −20° C. or higher. The acylation time is preferably 0.5 hours to 24 hours, more preferably 1 hour to 12 hours, and further preferably 1.5 hours to 6 hours. Below 0.5 hours the reaction does not advance sufficiently under ordinary conditions, and beyond 24 hours it is disadvantageous for industrial production.

(Reaction Terminator)

It is preferable to add a reaction terminator after the acylating reaction in the producing process for the cellulose acylate according to the present invention.

Any product that decomposes an acid anhydride may be used as a reaction terminator. Preferable examples thereof include water, alcohols, such as ethanol, methanol, propanol and isopropyl alcohol, and a composition containing the same. A reaction terminator may contain a neutralizer mentioned hereinbelow. In order to evade such an inconvenience that heat generation beyond the cooling capacity of the reactor should take place by addition of a reaction terminator which would cause decrease of the degree of polymerization of the cellulose acylate, or precipitation of the cellulose acylate in an undesired shape, it is preferable, rather than to add water or alcohol directly, to add a mixture of water and a carboxylic acid, such as acetic acid, propionic acid and butyric acid, especially preferable to use acetic acid as the carboxylic acid. The mixture ratio of a carboxylic acid and water may be selected arbitrarily, but the water content in a range of 5 mass-% to 80 mass-%, further 10 mass-% to 60 mass-%, and especially 15 mass-% to 50 mass-% is preferable.

A reaction terminator may be added to a reactor for acylation, or the reaction product may be added to a container of a reaction terminator. It is preferable to add a reaction terminator over 3 min to 3 hours. In case the addition time is beyond 3 min, an inconvenience, such as too severe heat generation causing decrease of the degree of polymerization; insufficient hydrolysis of the acid anhydride; and deterioration of the stability of the cellulose acylate, will be favorably avoided. Further, in case the addition time of a reaction terminator is 3 hours or less, there will be no problem about decrease in the industrial productivity. The addition time of a reaction terminator is preferably 4 min or longer and 2 hours or shorter, more preferably 5 min or longer and 1 hour or shorter, and further preferably 10 min or longer and 45 min or shorter. Although a reaction terminator may be added with or without the reactor cooling, it is preferable to cool the reactor to suppress the temperature rise in order to suppress depolymerization. Further, it is preferable to chill a reaction terminator in advance.

(Neutralizer)

In or after the acylation-termination step, a neutralizer (e.g., carbonates, acetates, hydroxides or oxides of calcium, magnesium, iron, aluminum or zinc) or a solution thereof may be added to the system for the purpose of hydrolyzing the excessive carboxylic acid anhydride remaining therein, or neutralizing a part or all of the carboxylic acid and the esterification catalyst therein. Preferable examples of a solvent for the neutralizer include water, alcohols (e.g., ethanol, methanol, propanol and isopropyl alcohol), carboxylic acids (e.g., acetic acid, propionic acid and butyric acid), ketones (e.g., acetone and ethyl methyl ketone), and other polar solvents such as dimethylsulfoxide, and mixed solvents thereof.

(Partial Hydrolysis)

The cellulose acylate thus obtained has a total degree of substitution of approximately 3, but in general for the purpose of obtaining a product having a desired substitution degree, the ester bonds of the produced cellulose acylate are partially hydrolyzed by standing in the presence of a small amount of a catalyst (generally, the remaining acylation catalyst such as sulfuric acid) and water, at 20 to 90° C. for a few minutes to a few days, so that the degree of acyl substitution of the cellulose acylate is reduced to a desired level (usually referred to as “maturation”). Since in the course of partial hydrolysis, the sulfate ester of cellulose is also hydrolyzed, by selecting the hydrolysis condition, the amount of the sulfate ester bonding to cellulose may be reduced.

It is preferable to stop the partial hydrolysis by neutralizing completely the catalyst remaining in the system with the above-mentioned neutralizer or a solution thereof, as soon as a desired cellulose acylate is obtained. It is also desirable to remove efficiently the catalyst (e.g. sulfate ester) in the reaction solution or bound to the cellulose by adding a neutralizer (e.g. magnesium carbonate and magnesium acetate) forming a salt having low solubility in the solution.

(Filtration)

It is preferable to filtrate the reaction mixture (dope) to remove or reduce unreacted materials, insoluble salts and other foreign matters in the cellulose acylate. The filtration may be conducted at any stage between the completion of acylation and reprecipitation. It is also appropriate to dilute the mixture with a suitable solvent before the filtration to control the filtration pressure or the handling property.

(Reprecipitation)

From the cellulose acylate solution thus obtained, the cellulose acylate is reprecipitated by adding the solution into a poor solvent, such as water or aqueous solution of a carboxylic acid (e.g. acetic acid, propionic acid), or admixing a poor solvent with the cellulose acylate solution, and the precipitate is washed and stabilized to obtain the object cellulose acylate. The reprecipitation may be carried out continuously or batchwise for a constant amount. It is also preferable to control the shape or the molecular weight distribution of the reprecipitated cellulose acylate, by adjusting the concentration of the cellulose acylate solution or the composition of the poor solvent depending on the substitution type or the degree of polymerization of the cellulose acylate.

(Washing)

The produced cellulose acylate should be preferably subjected to a washing treatment. Any solvent, in which the solubility of cellulose acylate is low, and which can remove impurities, may be used as a washing solvent. However, usually water or hot water is used. The temperature of washing water is preferably 25° C. to 100° C., more preferably 30° C. to 90° C., and further preferably 40° C. to 80° C. Washing may be carried out batchwise repeating filtration and change of washing liquid, or by a continuous washing apparatus. It is preferable to reuse the waste liquid generated in the steps of reprecipitation and washing as a poor solvent for the reprecipitation step, or to recover for reuse a solvent such as a carboxylic acid by means of distillation or the like.

The progress of washing may be trace by any means, and as preferable methods are exemplified hydrogen ion concentration, ion chromatography, electric conductivity, ICP, elementary analysis, and atomic absorption spectrometry methods.

By the above treatments, a catalyst (e.g. sulfuric acid, perchloric acid, trifluoroacetic acid, p-toluenesulfonic acid, methanesulfonic acid and zinc chloride), a neutralizer (e.g. a carbonate, an acetate, a hydroxide or an oxide of calcium, magnesium, iron, aluminum or zinc), a reaction product of a neutralizer and a catalyst, a carboxylic acid (e.g. acetic acid, propionic acid, butyric acid), and a reaction product of a neutralizer and a carboxylic acid in the cellulose acylate may be removed, which is effective for increasing the stability of the produced cellulose acylate.

(Stabilization)

In order to improve the stability further or to reduce the odor of a carboxylic acid, it is also preferable to treat the cellulose acylate washed by hot water with an aqueous solution of a weak alkali (e.g. a carbonate, a hydrogencarbonate, a hydroxide and an oxide of sodium, potassium, calcium, magnesium or aluminum).

The amount of residual impurities may be controlled by the quantity of a washing liquid, the washing temperature and time, the stirring method and shape of the washing vessel, and the composition and concentration of the stabilizer. According to the present invention, the conditions for acylation, partial hydrolysis and washing are selected to make the residual sulfate ion concentration (as the content of sulfur atom) in a range of 0 to 500 ppm.

(Drying)

In the present invention, to control the water content of a cellulose acylate to a preferable amount, it is preferable to dry cellulose acylate. Although there is no restriction on a method of drying, insofar as a desired water content can be attained, heating, aeration, vacuum or stirring may be preferably employed singly or in combination for effective drying. The drying temperature is preferably 0 to 200° C., more preferably 40 to 180° C., and further preferably 50 to 160° C. The water content of the cellulose acylate of the present invention is preferably 2 mass-% or less, more preferably 1 mass-% or less, and further preferably 0.7 mass-% or less.

(Morphology)

Although the cellulose acylate of the present invention can be in various forms as: granule, powder, fiber and lump, as a raw material for a film production, a granular or powder form is preferable. Therefore, for homogeneous granular size and easier handling, the dried cellulose acylate may be subjected to milling or sieving. In case cellulose acylate is in a granular form, 90 mass-% or more of the granules to be used have preferably the granule size of 0.5 to 5 mm, and 50 mass-% or more of the granules to be used have preferably the granule size of 1 to 4 mm. The shape of the cellulose acylate granules is preferably as spherical as possible. The apparent density of the cellulose acylate granules of the present invention is preferably 0.5 to 1.3, more preferably 0.7 to 1.2, and further preferably 0.8 to 1.15, wherein a method for determining the apparent density is stipulated in JIS K-7365.

The angle of repose of the cellulose acylate granules of the present invention is preferably 10 to 70°, more preferably 15 to 600, and further preferably 20 to 500.

(Degree of Polymerization)

The degree of polymerization of the cellulose acylate to be used preferably according to the present invention is 100 to 300 (as the average degree of polymerization), preferably 120 to 250, and more preferably 130 to 200. The average degree of polymerization can be determined by a measurement according to the intrinsic-viscosity method by Uda et al. (Uda K., Saito H., Journal of the Society of Fiber science and Technology, Japan (Sen'i Gakkaishi), vol. 18 (1), 1962, p. 105-120), or by a measurement of the molecular weight distribution according to the gel permeation chromatography method (GPC). The details are also described in Japanese Patent Application Laid-Open No. 09-95538.

According to the present invention, the ratio of (the weight average degree of polymerization) to (the number average degree of polymerization) of the cellulose acylate according to GPC is preferably 1.6 to 3.6, more preferably 1.7 to 3.3, and further preferably 1.8 to 3.2.

A single type of the cellulose acylates may be used, or in combination of two or more types. Further a polymer component other than a cellulose acylate may be appropriately mixed. The polymer component to be mixed is preferably well compatible with a cellulose ester, and the film formed therefrom has the transmittance of 80% or higher, more preferably 90% or higher, and further preferably 92% or higher.

[Examples of Synthesis of Cellulose Acylate]

Examples of synthesis of a cellulose acylate used according to the present invention will be described in more details below, provided that the present invention should not be limited thereto.

### Synthesis Example 1

### Synthesis of Cellulose Acetate Propionate

In a 5 L-separable flaskreactor with a reflux device were charged 150 g of cellulose (hard-wood pulp) and 75 g of acetic acid, which was then heated in an oil bath adjusted to 60° C. with vigorous stirring for 2 hours. The thus pretreated cellulose was swollen, opened and fluffy. The reactor was cooled in an ice-water bath at 2° C. for 30 min.

An acylating agent was prepared separately as a mixture of 1,545 g of propionic anhydride and 10.5 g of sulfuric acid, which was then cooled to −30° C. and added at one time to the reactor containing the as above pretreated cellulose. After elapse of 30 min, the temperature outside the reactor was gradually raised adjusting the internal temperature to reach 25° C. at 2 hours after the addition of the acylating agent. The reactor was cooled in an ice-water bath at 5° C. adjusting the internal temperature to reach 10° C. at 0.5 hours after the addition of the acylating agent, and 23° C. at 2 hours, and then stirred for another 3 hours maintaining the inner temperature at 23° C. The reactor was cooled in an ice-water bath at 5° C. and 120 g of acetic acid containing 25 mass-% water pre-cooled to 5° C. was added over 1 hour. After raising the internal temperature to 40° C., the reactor was stirred for 1.5 hours. Then a solution of magnesium acetate tetrahydrate in an amount of 2 mol equivalent of the sulfuric acid dissolved in acetic acid containing 50 mass-% water was added to the reactor, which was then stirred for 30 min. Then 1 L of acetic acid containing 25 mass-% water, 500 mL of acetic acid containing 33 mass-% water, 1 L of acetic acid containing 50 mass-% water, and 1 L of water were added in the order mentioned to precipitate cellulose acetate propionate. The obtained precipitate of cellulose acetate propionate was washed with hot water. Thereby, by changing the washing conditions, cellulose acetate propionates with various contents of residual sulfate ion were obtained. After washing, the product was stirred in an aqueous solution of 0.005 mass-% calcium hydroxide at 20° C. for 0.5 hours, and washed further with water until the pH of the water after washing became 7, which was then dried under vacuum at 70° C.

According to measurements by 1H-NMR and GPC, the obtained cellulose acetate propionate had the degree of acetylation of 0.30, the degree of propionylation of 2.63, and the degree of polymerization of 320. The content of sulfate ion was measured according to ASTM D-817-96.

### Synthesis Example 2

### Synthesis of Cellulose Acetate Butyrate

In a 5 L-separable flask reactor with a reflux device were charged 100 g of cellulose (hard-wood pulp) and 135 g of acetic acid, which was then left standing for 1 hour being heated in an oil bath adjusted to 60° C. Then the reactor was heated in an oil bath adjusted to 60° C. with vigorous stirring for 1 hour. The thus pretreated cellulose was swollen, opened and fluffy. The reactor was cooled in an ice-water bath at 5° C. for 1 hour to cool down the cellulose adequately.

An acylating agent was prepared separately as a mixture of 1,080 g of butyric anhydride and 10.0 g of sulfuric acid, which was then cooled to −20° C. and added at one time to the reactor containing the as above pretreated cellulose. After elapse of 30 min, the temperature of an external heating device was gradually raised to 20° C. allowing reaction for 5 hours. The reactor was cooled in an ice-water bath at 5° C. and 2,400 g of acetic acid containing 12.5 mass-% water pre-cooled to approximately 5° C. was added over 1 hour. After raising the internal temperature to 30° C., the reactor was stirred for 1 hour. Then 100 g of a 50 mass-% aqueous solution of magnesium acetate tetrahydrate was gradually added to the reactor, which was then stirred for 30 min. Then 1,000 g of acetic acid and 2,500 g of acetic acid containing 50 mass-% water were added gradually to precipitate cellulose acetate butyrate. The obtained cellulose acetate butyrate was washed with hot water. Thereby, by changing the washing conditions, cellulose acetate butyrates with various contents of residual sulfate ion were obtained. After washing, the product was stirred in an aqueous solution of 0.005 mass-% calcium hydroxide for 0.5 hours, and washed further with water until the pH of the water after washing became 7, which was then dried under vacuum at 70° C. The obtained cellulose acetate butyrate had the degree of acetylation of 0.84, the degree of butyrylation of 2.12, and the degree of polymerization of 268.

(4) Other Additives

(i) Matting Agent

It is preferable to add fine particles as a matting agent. Example of fine particles to be used according to the present invention include silicon dioxide, titanium dioxide, aluminium oxide, zirconium oxide, calcium carbonate, calcium carbonate, talc, clay, calcined kaolin, calcined calcium silicate, hydrated calcium silicate, aluminum silicate, magnesium silicate and calcium phosphate. Particles containing silicon are preferable in view of the resulted low turbidity, and silicon dioxide is especially preferable. The silicon dioxide powder with the average primary particle size of 20 nm or less and the apparent specific gravity of 70 g/L or higher is preferable. The primary particle with a small average size of 5 to 16 nm is more preferable, because the film haze can be lowered. The apparent specific gravity is preferably 90 to 200 g/L or higher, and more preferably 100 to 200 g/L or higher. The higher the apparent specific gravity is, the higher concentration dispersion can be prepared, which is preferable in view of better haze and aggregate property.

The fine particles generally form a secondary particle with the average particle size of 0.1 to 3.0 μm, which exists in a film as an aggregate of primary particles and generates surface roughness of 0.1 to 3.0 μm. The average secondary particle size is preferably 0.2 μm to 1.5 μm, more preferably 0.4 μm to 1.2 μm, and further preferably 0.6 μm to 1.1 μm. The primary and secondary particle size were determined by observing the particles in a film with a scanning electron microscope, thereby the diameter of the circumcircle for a particle was defined as the particle size. Further thereby, 200 particles at different locations were observed and the average of the determined values was deemed as the average particle size.

Examples of the fine particles of silicon dioxide commercially available for use include Aerosil R972, R972V, R974, R812, 200, 200V, 300, R202, OX50 and TT600 (these are all manufactured by Nippon Aerosil Co., Ltd.). Examples of the fine particles of zirconium oxide commercially available for use include Aerosil R976 and R811 (manufactured by Nippon Aerosil Co., Ltd.).

Among them Aerosil 200V and Aerosil R972V are especially preferable fine particles of zirconium oxide having the average primary particle sizes of 20 nm or less, and the apparent specific gravity of 70 g/L or more, which has strong activity to lower the frictional coefficient while keeping the turbidity of an optical film low.

(ii) Miscellaneous Additives

Besides the aforementioned additives, various additives such as a UV screening agent (e.g. a hydroxybenzophenone compound, a benzotriazole compound, a salicylic acid ester compound, and a cyanoacrylate compound), an infrared absorber, an optical modifier, a surfactant, and an odor-trapping agent (amine, etc.) may be added. These materials whose details are described in Journal of Technical Disclosure (Disclosure No. 2001-1745, published on 15 Mar. 2001 by the Japan Institute of Invention and Innovation, p. 17 to 22), can be favorably utilized.

An example of an infrared absorbing dye that can be used is disclosed in Japanese Patent Application Laid-Open No. 2001-194522, and an example of a UV absorber that can be used is disclosed in Japanese Patent Laid-Open Application No. 2001-151901, and the preferable contents thereof are respectively 0.001 to 5 mass-% with respect to a cellulose acylate.

As an optical modifier, a retardation modifier may be exemplified, and those disclosed in Japanese Patent Application Laid-Open No. 2001-166144, Japanese Patent Application Laid-Open No. 2003-344655, Japanese Patent Application Laid-Open No. 2003-248117 and Japanese Patent Application Laid-Open No. 2003-66230 can be used to adjust the in-plane retardation (Re) and the thickness-direction retardation (Rth). The addition amount is preferably 0 to 10 wt %, more preferably 0 to 8 wt %, and further preferably 0 to 6 wt %.

(5) Physical Properties of Cellulose Acylate Composition

The cellulose acylate composition (mixture of cellulose acylate, a plasticizer, a stabilizer and other additives) should preferably satisfy the following requirements concerning the physical properties.

(i) Weight Loss

The weight loss rate on heating at 220° C. of the thermoplastic cellulose acetate propionate composition of the present invention is 5 weight-% or less. Thereby the weight loss rate on heating refers to the rate of weight loss of a sample at 220° C., when the sample temperature is increased from room temperature at a temperature-increase rate of 10° C./min under a nitrogen atmosphere. Formulating the cellulose acylate composition, the weight loss rate on heating can be decreased to 5 weight-% or below. It is more preferably 3 weight-% or below, and further preferably 1 weight-% or below. Owing to the above, the trouble (bubbling) during film formation can be suppressed.

(ii) Melt Viscosity

The melt viscosity (at 220° C., 1 sec⁻¹) of the thermoplastic cellulose acetate propionate composition of the present invention is preferably 100 to 1,000 Pa·sec, more preferably 200 to 800 Pa·sec, and further preferably 300 to 700 Pa·sec. At this high level of melt viscosity, stretching by a tension at the die outlet does not occur, so that increase of the optical anisotropy (retardation) due to orientation by stretching can be avoided.

For adjustment of the melt viscosity, any method may be applied, and is attainable, for example, by adjusting the degree of polymerization of the cellulose acylate or the addition amount of the plasticizer.

(6) Pelletization

The cellulose acylate and additives are preferably mixed and pelletized prior to the melt-extrusion film formation.

Although it is preferable to dry the cellulose acylate and additives prior to pelletization, it may be omitted by using a vented extruder. In case drying is conducted, a method that the material is heated in an oven at 90° C. for 8 hours or longer, is applicable, but not limited thereto. Pelletization can be done by melting the cellulose acylate and additives by a twin screw kneading extruder at 150° C. or higher and 250° C. or lower, and extruding strands like noodles, which are solidified in water and then cut to pellets. An under-water cut pelletizing method is also applicable, by which the melt being extruded directly from the die into water is cut to pellets.

Insofar as melting and kneading is sufficiently performed, any publicly known extruder, such as a single screw extruder, a non-intermeshing and counter-rotating twin screw extruder, an intermeshing and counter-rotating twin screw extruder and an intermeshing and co-rotating twin screw extruder, may be used.

Concerning the size of the pellet, preferably the cross-section is 1 mm² or more and 300 mm² or less and the length is 1 mm or more and 30 mm or less, more preferably the cross-section is 2 mm² or more and 100 mm² or less and the length is 1.5 mm or more and 10 mm or less.

By pelletization, the additives may be fed through a feeding port located at the middle part of the extruder or a venting port.

The rotating speed of the extruder is preferably 10 rpm to 1,000 rpm, more preferably 20 rpm to 700 rpm, and further preferably 30 rpm to 500 rpm. In case the rotating speed is below the above range, the residence time becomes too long and due to thermal degradation the molecular weight may be decreased and yellowish discoloration may occur unfavorably. In case the rotating speed is too high, scissions of molecules by shearing are increased, which generates problems, such as decrease of the molecular weight, or increase of gel generation by cross-linking.

The extruder residence time by pelletization is 10 sec or longer and 30 min or shorter, more preferably 15 sec or longer and 10 min or shorter, and further preferably 30 sec or longer and 3 min or shorter. Insofar as sufficient melting can be attained, a shorter residence time is preferable, because deterioration of the resin and discoloration can be minimized.

(7) Melt-extrusion Film Formation

(i) Drying

Preferably, the pellet prepared as above is used, whose water content is preferably lowered prior to film melt-casting.

To control the water content of the cellulose acylate according to the present invention at a desired level, it is preferable to dry the cellulose acylate. Although a dehumidified air dryer is frequently used, there is no particular restriction on a drying method, insofar as the desired water content can be attained. It is preferable to use such means as heating, aeration, vacuuming and stirring, singly or in combination for efficient dying, and further preferable to construct a dying hopper with an insulated structure. The drying temperature is preferably 0 to 200° C., more preferably 40 to 180° C., and further preferably 60 to 150° C. Too low drying temperature is not preferable, because drying requires a longer time period and the desired water content may not be reached. Reversely, too high drying temperature may cause blocking by adhesion of the resin. The air flow rate is preferably 20 to 400 m³/hour, more preferably 50 to 300 m³/hour, and further preferably 100 to 250 m³/hour. Too low air flow rate is not preferable due to low drying efficiency. The flow rate beyond a certain limit is uneconomic, because improvement of the drying efficiency flattens. The dew point of the air is preferably 0 to −60° C., more preferably −10 to −50° C., and further preferably −20 to −40° C. The drying time requires at least 15 min, more preferably 1 hour or longer, and further preferably 2 hours or longer. On the other hand drying beyond 50 hours, the additional decreasing effect of the water content is minimal, while there arises a fear of thermal deterioration of the resin. Therefore too long drying is not preferable. The water content of the cellulose acylate of the present invention is preferably 1.0 mass-% or less, more preferably 0.1 mass-% or less, and further preferably 0.01 mass-% or less.

(ii) Melt Extrusion

The cellulose acylate is fed through a feeding port into a cylinder of an extruder (different from the extruder for pelletization). In the cylinder are arranged a feed zone (zone A), where the cellulose acylate resin fed from the feeding port is transported constantly, a compression zone (zone B), where the cellulose acylate resin is kneaded and compressed and a metering zone (zone C), where the kneaded and compressed cellulose acylate resin is metered, from the feeding port side in the mentioned order. The resin is preferably dried according to the aforedescribed method to decrease the water content, and further, to prevent oxidation of the molten resin by residual oxygen, an operation either with an inert gas (e.g. nitrogen) sweeping inside the extruder, or with vacuum evacuation using a vented extruder is preferable. The compression ratio of the extruder screw is set at 2.5 to 4.5, and L/D is set at 20 to 70. Thereby the screw compression ratio represents a volume ratio of the feed zone A to the metering zone C, namely represents the quotient of (a volume of the feed zone A per unit length) by (a volume of the metering zone C per unit length) and is calculated using the outer diameter d1 of the screw shaft in the feed zone A, the outer diameter d2 of the screw shaft in the metering zone C, the channel depth a1 in the feed zone A, and the channel depth a2 in the metering zone C. Further, L/D represents the ratio of the cylinder inner diameter to the cylinder length. The extruding temperature is set at 190 to 240° C. If the temperature in the extruder exceeds 240° C., it is preferable to install a cooler between the extruder and the die.

If the screw compression ratio is so small as below 2.5, kneading becomes insufficient which may lead to generation of unmolten solids, to insufficient generation of the shearing heat to cause insufficient melting of crystals, leaving minute crystallites in the produced cellulose acylate film, and further to vulnerability to bubble mixing. In such event, the cellulose acylate film having decreased strength is produced, or when a cellulose acylate film is stretched, the remaining crystallites would deteriorate stretchability leading to poor orientation. On the contrary, if the screw compression ratio is so large as above 4.5, heat generation by too high shearing force could lead to possible deterioration of the resin and yellowish discoloration of the produced cellulose acylate film. Further too high sharing stress could cause molecular scission lowering the molecular weight and the mechanical strength of the film. Consequently to prevent yellowish discoloration of the produced cellulose acylate film and breakage during stretching, the screw compression ratio is preferably in a range of 2.5 to 4.5, more preferably in a range of 2.8 to 4.2, and further preferably in a range of 3.0 to 4.0.

If L/D is so small as below 20, insufficient melting or insufficient kneading can take place, and as in the case of too small compression ratio, minute crystallites tend to remain in a produced cellulose acylate film. Reversely, if L/D is so large as beyond 70, the residence time of the cellulose acylate resin in the extruder becomes too long, and the resin becomes vulnerable to deterioration. The longer residence time leads to molecular scission to lower the molecular weight and mechanical strength of the film. Consequently to prevent yellowish discoloration of the produced cellulose acylate film and breakage during stretching, the L/D is preferably in a range of 20 to 70, more preferably in a range of 22 to 65, and further preferably in a range of 24 to 50.

The extrusion temperature is preferably set at the temperature range described above. The cellulose acylate film thus obtained has such characteristic values as: the haze of 2.0% or less, and the yellow index (Y1 value) of 10 or less.

Wherein, the haze can be an index to show whether the extrusion temperature is too low, in other words, an index to show the quantity of crystallites remaining in the produced cellulose acylate film. If the haze exceeds 2.0, decrease of the strength of the produced cellulose acylate film, and breakage during stretching tend to occur more frequently. While, the yellow index (Y1) can be an index to show whether the extrusion temperature is too high. If the yellow index (Y1) is 10 or below, there is no concern about yellowness.

Concerning the type of an extruder, a single screw extruder is more frequently used owing to its relatively low equipment cost. Among various screw types, such as full flight-, Maddock- and Dulmage-type, the full flight type is preferable in view of rather poor thermal stability of the cellulose acylate resin. On the other hand, although the equipment cost being higher, a twin screw extruder may be used, which screw segment may be rearranged to place a venting port capable of venting out unnecessary volatile matters, while extrusion is in progress. The twin extruder may be classified into 2 large groups of a co-rotating type and a counter-rotating type. Although both types can be used, the co-rotating type is preferable, because a stasis space is hardly formed and self-cleaning activity is high. Although the equipment cost is high, since kneading capability is high, resin supplying capacity is high and extrusion at lower temperature is possible, the twin screw extruder is suitable for film formation of the cellulose acetate resin. Placing a venting port appropriately, the cellulose acylate pellet or powder without drying may be used for the extrusion. Further, direct reuse of a trim generated in the film formation process without pre-dying is possible.

Although the preferable screw diameter varies depending on the desired extrusion amount per unit time, it is in a range of 10 mm or more and 300 mm or less, more preferably 20 mm or more and 250 mm or less, and further preferably 30 mm or more and 150 mm or less.

(iii) Filtering

It is preferable to conduct filtering by a so-called breaker-plate with a filter medium at the discharge port of the extruder to eliminate foreign matters in the resin and to avoid damages on a gear pump by foreign matters. Furthermore, to remove foreign matters at higher accuracy, it is preferable to install a filter mounted with so-called leaf disc filter elements after the gear pump. Filtering may be conducted by a single-stage filter installed at one location or by multi-stage filters installed at several locations. Although higher filtration accuracy is desirable, from the constraints of the pressure resistance of the filtering medium and increase of the filtration pressure by clogging of the filtering medium, the filtration accuracy is preferably 15 μm to 3 μm, and more preferably 10 μm to 3 μm. In case a filter with leaf disc filter elements is used as a final filter of foreign matters, a filtering medium with the quality of high filtration accuracy is preferably used, and to assure the requirements of pressure resistance and durability of the filter, the number of the mounted filter elements may be adjusted. In view of the use under high temperature and high pressure, the material of the filtering medium is preferably a ferrous material, among ferrous materials preferably a stainless steel or a steel, especially preferably a stainless steel in view of the corrosion stability. Concerning the structure of the filtering medium, a woven wire medium and a sintered medium prepared by sintering long metallic fibers or metallic powders can be used, and the sintered filter is preferable in view of the filtration accuracy and the filter durability.

(iv) Gear Pump

To improve the thickness accuracy of a film, it is important to reduce the fluctuation of the extrusion rate, and it is effective to provide a gear pump between the extruder and the die, so that the cellulose acylate resin can be supplied at a constant rate. The gear pump is composed of a pair of gears, a driving gear and a driven gear, engaged each other and mounted in a housing. When the driving gear is driven, the engaged driven gear is rotated together to suck the molten resin into the cavity of the pump through a suction port formed in the housing and the molten resin is extruded at a constant rate from a delivery port formed in the housing. Even if the resin pressure at the outlet of the extruder fluctuates slightly, a gear pump absorbs such fluctuation and the pressure fluctuation at a downstream section of the film formation equipment becomes minimal and the thickness accuracy is improved. By use of a gear pump, the fluctuation of the resin pressure at the die can be controlled within ±1%.

In order to improve the flow rate constancy of a gear pump, a method may be applied, by which the pressure before the gear pump is regulated to a constant level by changing the rotation speed of the screw. Alternatively, a high accuracy gear pump having 3 or more gears to overcome the fluctuation of the gears may be effectively used.

Another advantage of the use of a gear pump is that the film formation is possible with the lower pressure at the screw head, by which saving of energy consumption, prevention of the resin temperature increase, improvement of transportation efficiency, reduction of the residence time in the extruder, and curtailment of L/D of the extruder can be expected. In case a filter is used to remove foreign matters, with the increase of the filtration pressure the supply rate of the resin from the extruder may change, which can be avoided if a gear pump is used together. Care should be taken concerning such disadvantages of the gear pump that the facility length and the residence time of the resin may become long depending on the selection of the equipment, or that scissions of the molecular chains may be caused by the shearing force of a gear pump.

The residence time of the resin from the incoming of the resin into the extruder through the feeding port until the outgoing through the die is preferably 2 min or longer and 60 min or shorter, more preferably 3 min or longer and 40 min or shorter, and further preferably 4 min or longer and 30 min or shorter.

When the flow of a polymer circulating through the bearing of a gear pump is disturbed, the sealing by the polymer at a driving section and the bearing section may be compromised, and such troubles as increase of fluctuations in the flow rate or the delivery pressure may be caused. To cope with such problems, designing of the gear pump (especially clearance) specific to the melt viscosity of the cellulose acylate resin is required. Further, since a stasis space in the gear pump may cause degradation of the cellulose acylate resin, a structure with least stasis space is preferable. The polymer piping or adapters used for connecting the extruder and the gear pump, or the gear pump and the die, should be designed to minimize such stasis spaces, as well as to minimize the temperature fluctuation, so that the extrusion pressure of the cellulose acylate resin having the highly temperature dependent melt viscosity can be stabilized. Although a band heater with low equipment cost is used generally for heating the polymer piping, it is more preferable to use a cast aluminum heater with less temperature fluctuation. Furthermore, for the sake of stabilization of the extrusion pressure of the extruder, the barrel of the extruder should be preferably heated for melting by a heater divided into 3 to 20 segments.

(v) Die

A cellulose acylate resin is molten by the extruder having the aforementioned structure and continuously fed to the die through, as the case may be, a filter and a gear pump. Insofar as designed with little stasis of the molten resin in the die, any of a commonly used T-die, a fish-tale die and a coat-hanger die can be used. Furthermore, a static mixer may be installed just before the T-die to improve the temperature uniformity of the resin. The clearance at the outlet of the T-die is in general 1.0 to 5.0-fold the film thickness, preferably 1.2 to 3-fold, and more preferably 1.3 to 2-fold. In case the lip clearance is 1.0-fold or less the film thickness, it is difficult to obtain a film of good planar quality. On the contrary, in case the lip clearance is 5.0-fold or more the film thickness, the accuracy of the film thickness is unfavorably compromised. Since the die is an extremely important equipment to determine the thickness accuracy of the film, it is preferable to employ a die capable of severely controlling the thickness. The thickness of a film can be controlled by a die in general at a pitch of 40 mm to 50 mm, but a die capable of regulating the film thickness preferably at a pitch of 35 mm or less, more preferably at a pitch of 25 mm or less, is preferable. Since the melt viscosity of the cellulose acylate is highly dependent on temperature and shear rate, it is important to design a die to minimize the temperature fluctuation and the flow rate cross-machine fluctuation of the die. Furthermore, a die equipped with an automatic thickness regulator is known, with which the downstream film thickness is measured and the deviation of the thickness is calculated, and by feedback of the same the die is regulated for a constant thickness. The use of a die equipped with such regulator is advantageous to decrease the thickness fluctuation in a long-time continuous production.

In general a mono-layer film producing equipment is used for producing a film owing to its low equipment cost, but, if necessary, a multi-layer film producing equipment may be used, so that a film having 2 or more structures by introducing a functional outer layer can be produced. Although it is generally preferable to prepare such a functional layer by laminating a thin layer on the surface layer, there is no particular restriction on the layer thickness ratio.

(vi) Casting

The molten resin is extruded as above from the die in a form of a sheet onto a chill drum, and chilled and solidified there to obtain a film. In this occasion, tight binding between the chill drum and the melt-extruded sheet should preferable be promoted using a static charge method, an air knife method, an air chamber method, a vacuum nozzle method, a touch roll method, and the like. Such a binding promoting method may be applied to the total or a part of the melt-extruded sheet. Especially, a method called as “edge pinning”, by which only both the edge parts of a film are pressed to the drum, is applied frequently, but not limited thereto.

Preferably a plurality of chill drums are used for slow cooling. In general, 3 chill drums are used, but not limited thereto. The diameter of the chill drums should be preferably 100 mm or more and 1,000 mm or less, and more preferably 150 mm or more and 1,000 mm or less. The distance between the plurarity of chill drums, in case a plurality of drums exist, should be in terms of a surface to surface distance preferably 1 mm or more and 50 mm or less, and more preferably 1 mm or more and 30 mm or less.

The temperature of the chill drums is preferably 60° C. or higher and 190° C. or lower, more preferably 70° C. or higher and 150° C. or lower, and further preferably 80° C. or higher and 140° C. or lower. The sheet is stripped off from the chill drum and wound up after passing a drawing roll (nip roll). The winding speed is preferably 10 m/min or more and 100 m/min or less, more preferably 15 m/min or more and 80 m/min or less, and further preferably 20 m/min or more and 70 m/min or less. The film formation width is preferably 0.7 m or more and 5 m or less, more preferably 1 m or more and 4 m or less, and further preferably 1.3 m or more and 3 m or less. The thickness of the thus obtained unstretched film is preferably 30 μm or more and 400 μm or less, more preferably 40 μm or more and 300 μm or less, and further preferably 50 μm or more and 200 μm or less.

In case a touch roll method is employed, the surface material of the touch roll may be a resin, such as rubber and Teflon (registered trade name), or a metal. Furthermore, a so-called flexible roll may be used, which is a metallic roll with a very thin wall and which surface is deformed slightly in a concave form increasing the contact area by the touching pressure.

The temperature of the touch roll is preferably 60° C. or higher and 160° C. or lower, more preferably 70° C. or higher and 150° C. or lower, and further preferably 80° C. or higher and 140° C. or lower.

(vii) Winding

The sheet thus obtained is preferably trimmed at both the edges and wound up. The trim may be after crushing or, if necessary, being subjected to a treatment, such as pelletizing, depolymerization, and repolymerization, reused as a raw material for the same or different type of the film. Any type of the cutter may be used for trimming including a rotary cutter, a shear blade and a knife. Concerning the material therefor, either of a carbon steel and a stainless steel can be used. In general a carbide blade and a ceramic blade are preferable, because they have long blade durability and generate less blade chips.

It is preferable to laminate a film on at least one surface before winding in view of protection against physical damages. The winding tension is preferably 1 kg/m-width or more and 50 kg/m-width or less, more preferably 2 kg/m-width or more and 40 kg/m-width or less, and further preferably 3 kg/m-width or more and 20 kg/m-width or less. In case the winding tension is below 1 kg/m-width, uniform winding of the film is difficult. Reversely, in case the winding tension is beyond 50 kg/m-width, it will lead to unfavorable tight winding of the film, which not only deteriorates the appearance of the film reel, but also elongates the film at a bulge of the reel by creeping to cause waving of the film or generation of residual birefringence by the film elongation. It is preferable to detect the winding tension by the on-line tension controller and to wind up the film controlling the winding tension at a constant level. In case there is a difference in the film temperature locationwise in the film formation line, the film length may be slightly different due to thermal expansion, therefore the draw rate between the nip rolls should be adjusted, so that the determined film tension limit be not exceeded at any part of the line.

Although it is possible to wind up the film with a constant winding tension under a control of a tension controller, it is more preferable to change the tension gradually adapting appropriately to the wound reel diameter. In general, with the increase of the wound reel diameter, the tension is gradually decreased. However, in some cases, with the increase of the wound reel diameter, the tension should better be increased.

(viii) Physical Properties of Unstretched Film of Cellulose Acylate

The thus obtained unstretched cellulose acylate film preferably exhibits Re=0 to 20 nm and Rth=0 to 80 nm, more preferably Re=0 to 15 nm and Rth=0 to 70 nm, and further preferably Re=0 to 10 nm and Rth=0 to 60 nm, wherein Re represents in-plane retardation, and Rth represents thickness-direction retardation. Re is measured by KOBRA 21 ADH (Oji Scientific Instruments) with the incident light along the normal line of the film. Rth is calculated based on retardation values measured in total three directions. One is the Re and others are retardation values measured with an incident light at an tilted angle of +40° and −40° relative to the normal line of the film, by tilting around the rotation axis which is fit to the in-plane slow axis. The angle (θ) between the machine direction (longitudinal direction) and the slow axis of Re of the film is preferably as close to 0°, +90° or −90° as possible.

The light transmission is preferably 90% to 100%, more preferably 91% to 99%, and further preferably 92% to 98%. The haze is preferably 0 to 1%, more preferably 0 to 0.8%, and further preferably 0 to 0.6%.

The thickness unevenness is both in the machine direction and in the cross-machine direction preferably 0% or more and 4% or less, more preferably 0% or more and 3% or less, and further preferably 0% or more and 2% or less.

The tensile modulus is preferably 1.5 kN/mm² or more and 3.5 kN/mm² or less, more preferably 1.7 kN/mm² or more and 2.8 kN/mm² or less, and further preferably 1.8 kN/mm² or more and 2.6 kN/mm² or less.

The fracture elongation is preferably 3% or more and 100% or less, more preferably 5% or more and 80% or less, and further preferably 8% or more and 50% or less.

The Tg of the film (namely, Tg of the mixture of a cellulose acylate and additives) is preferably 95° C. or higher and 145° C. or lower, more preferably 100° C. or higher and 140° C. or lower, and further preferably 105° C. or higher and 135° C. or lower.

The thermal dimensional change at 80° C. per day is both in the machine direction and in the cross-machine direction preferably 0% or higher and ±1% or less, more preferably 0% or higher and ±0.5% or less, and further preferably 0% or higher and ±0.3% or less.

The water permeability at 40° C. and 90% RH is preferably 300 g/(m²·day) or more and 1,000 g/(m²·day) or less, more preferably 400 g/(m²·day) or more and 900 g/(m²·day) or less, and further preferably 500 g/(m²·day) or more and 800 g/(m²·day) or less.

The equilibrium water content at 25° C. and 80% RH is preferably 1 wt % or more and 4 wt % or less, more preferably 1.2 wt % or more and 3 wt % or less, and more preferably 1.5 wt % or more and 2.5 wt % or less.

(8) Stretching

The film produced according to the above method is stretched.

The stretching is carried out by setting a temperature inside a heating oven installed between a pair of rolls at Tg of the thermoplastic resin film+50° C. or higher and Tg+140° C. or lower, and stretching the thermoplastic resin film in the heating oven over a heating time of 1 sec or longer and 100 sec or shorter. By stretching the thermoplastic resin film slowly over a defined time period under a heated condition, the generating retardation can be precisely regulated without causing a defect on the film. The stretching is preferably carried out over the heating time of 1 sec or longer and 100 sec or shorter, more preferably of 15 sec or longer and 90 sec or shorter, and further preferably of 30 sec or longer and 60 sec or shorter.

The distance between the rolls is preferably 1 m or more and 100 m or less. By electing the distance spanning the rolls as long as 1 m or more and 100 m or less, the film between the rolls can be heated uniformly, and the stretching ratio can be regulated easily, so that an aimed retardation can be attained.

The stress of the thermoplastic resin film between the rolls should be preferably set in a range of 0.4 MPa or more and 8 MPa or less, which will facilitate the regulation of the stretching ratio.

It is preferable that no conveying rolls be installed inside the heating oven. The thermoplastic resin film may be floated for being conveyed inside the heating oven. Owing to such measures a scratch on the film surface can be prevented, which would be generated if conveying rolls supporting the film should be installed in the heating oven. Furthermore, by conveying the thermoplastic resin film on flotation in the heating oven, the stretching action by the own weight of the film can be suppressed and an effect of facilitating the regulation of the stretching ratio can be obtained. As a flotation method, air blowing from nozzles located above and beneath the thermoplastic resin film can be applied. The flotation height is preferably within 30 mm.

When the longitudinal stretching ratio for the film is more than 1.0 and 2.0 or less, a wrinkle or a scratch can be prevented and the retardation of the film can be regulated to a desired level.

The physical properties of the stretched cellulose acylate film are preferably in the following ranges.

The tensile modulus is preferably 1.5 kN/mm² or more and 3.0 kN/mm² or less, more preferably 1.7 kN/mm² or more and 2.8 kN/mm² or less, and further preferably 1.8 kN/mm² or more and 2.6 kN/mm² or less.

The fracture elongation is preferably 3% or more and 100% or less, more preferably 5% or more and 80% or less, and further preferably 8% or more and 50% or less.

The Tg of the film (namely, Tg of the mixture of a cellulose acylate and additives) is preferably 95° C. or higher and 145° C. or lower, more preferably 100° C. or higher and 140° C. or lower, and further preferably 105° C. or higher and 135° C. or lower.

The thermal dimensional change at 80° C. per day is both in the machine direction and in the cross-machine direction preferably 0% or higher and ±1% or less, more preferably 0% or higher and ±0.5% or less, and further preferably 0% or higher and 0.3% or less.

The water permeability at 40° C. and 90% is preferably 300 g/(m²·day) or more and 1,000 g/(m²·day) or less, more preferably 400 g/(m²·day) or more and 900 g/(m²·day) or less, and further preferably 500 g/(m²·day) or more and 800 g/(m²·day) or less.

The equilibrium water content at 25° C. and 80% RH is preferably 1 wt % or more and 4 wt % or less, more preferably 1.2 wt % or more and 3 wt % or less, and further preferably 1.5 wt % or more and 2.5 wt % or less.

The thickness is preferably 30 μm or more and 200 μm or less, more preferably 40 μm or more and 180 μm or less, and further preferably 50 μm or more and 150 μm or less.

The haze is preferably 0% or more and 3.0% or less, more preferably 0% or more and 2% or less, and further preferably 0% or more and 1% or less.

The light transmission is preferably 90% or more and 100% or less, more preferably 91% or more and 99% or less, and further preferably 92% or more and 98% or less.

(9) Surface Treatment

The unstretched or stretched cellulose acylate film can be improved in adhesion to various functional layers, such as a priming layer and a backing layer, by conducting a surface treatment. Examples of the applicable surface treatment include a glow discharge treatment, a UV irradiation treatment, a corona treatment, a flame treatment and an acid or alkali treatment. The glow discharge treatment may be a treatment by low-temperature plasma generated under a low gas pressure of 10⁻³ to 20 Torr or by plasma under the atmospheric pressure. A plasma excitation gas is a gas which can be excited to plasma under the aforementioned conditions, and examples thereof include argon, helium, neon, krypton, xenon, nitrogen, carbon dioxide, frons such as tetrafluoromethane, and mixtures thereof. Further details thereof are described in Journal of Technical Disclosure (Disclosure No. 2001-1745, published on 15 Mar. 2001 by the Japan Institute of Invention and Innovation, p. 30 to 32). In the atmospheric plasma treatment, which has recently drawn attention, irradiation energy of 20 to 500 kGy is applied under the conditions of 10 to 1,000 keV, more preferably irradiation energy of 20 to 300 kGy under the conditions of 30 to 500 keV is applied. Among others, the alkali saponification treatment is especially preferable, and an very effective surface pretreatment method for the cellulose acylate film. Details described in Japanese Patent Application Laid-Open Nos. 2003-3266, 2003-229299, 2004-322928 and 2005-76088 can be applicable.

The alkali saponification treatment may be conducted by dipping into a saponification liquid or by coating the same. In case of a dipping method, a film is dipped in a vessel containing an aqueous solution of NaOH or KOH (pH 10 to 14) heated to 20° C. to 80° C. passing through over 0.1 to 10 min, and then neutralized, washed with water and dried to complete the treatment.

In case of a coating method, such a method as a dip-coating method, a curtain coating method, an extrusion coating method, a bar coating method and an E-type coating method may be employed. A solvent of choice for the alkali saponification coating solution should preferably have good wettability in order to coat the saponification solution onto a transparent substrate and maintains the flat surface property without forming unevenness on the transparent substrate surface by the saponification solvent. More specifically, an alcoholic solvent is preferable and isopropyl alcohol is particularly preferable. Alternatively, an aqueous solution of a surfactant may be used as a solvent. The alkali of the alkali saponification coating solution is preferably dissolved in the aforementioned solvent, and KOH and NaOH are further preferable. The pH of the saponification coating solution is preferably 10 or higher, and more preferably 12 or higher. The alkali saponification reaction is preferably performed at room temperature for 1 sec or longer and 5 min or shorter, more preferably for 5 sec or longer and 5 min or shorter, and further preferably for 20 sec or longer and 3 min or shorter. After the alkali saponification reaction, the surface coated with the saponification solution is preferably washed with water or an acid followed by washing with water. The saponification coating treatment and the removal of a coat from an orientation film (described herein below) can be continuously performed to reduce the number of production steps. The saponification methods are more specifically described in Japanese Patent Application Laid-Open No. 2002-82226 and International Publication No. WO-02/46809.

It is preferable to make a primer layer for adhesion with a functional layer. A primer layer may be coated after the surface treatment or without the surface treatment. The details of a primer layer are described in Journal of Technical Disclosure (Disclosure No. 2001-1745, published on 15 Mar. 2001 by the Japan Institute of Invention and Innovation, p. 32).

The surface treatment and the priming step may by integrated in the last stage of the film forming process, or conducted independently, or conducted in the functional layer forming process (described below).

(10) Functional Layer Forming

It is preferable that the stretched or unstretched cellulose acylate film according to the present invention is combined with functional layers described in details in Journal of Technical Disclosure (Disclosure No. 2001-1745, published on 15 Mar. 2001 by the Japan Institute of Invention and Innovation, p. 32-45). Among others, it is preferable to form a polarizing layer (polarizer), an optical compensation layer (optical compensation film), an antireflection layer (anti-reflective film) and a hard coat layer.

(i) Polarizing Layer Forming (Formation of a Polarizer)

[Materials to be Used for a Polarizing Layer]

A polarizing layer presently on the market is generally formed by dipping a stretched polymer in a solution of iodine or a dichroic dye in a bath, which permeates to a binder in it. Alternatively, a polarizing membrane formed by coating, for example, of a product by Optiva Inc. may be used. The iodine and dichroic dye in the polarizing membrane are oriented in the binder to express polarizing activity. Examples of the dichroic dye include an azo dye, a stilbene dye, a pyrazolone dye, a triphenylmethane dye, a quinoline dye, an oxazine dye, a thiazine dye and an anthraquinone dye. The dichroic dye is preferably water-soluble and preferably has a hydrophilic substituent such as sulfo, amino, and hydroxyl groups. More specifically, a compound described in Journal of Technical Disclosure (Disclosure No. 2001-1745, published on 15 Mar. 2001 by the Japan Institute of Invention and Innovation, p. 58) may be exemplified.

As the binder of the polarizing membrane, both a self-crosslinkable polymer and a polymer crosslinkable by a cross-linking agent may be used, and further a plurality of combinations thereof may be used. Examples of the binder include a methacrylate copolymer, a styrene copolymer, a polyolefin, a polyvinyl alcohol, a modified polyvinyl alcohol, poly(N-methylolacrylamide), a polyester, a polyimide, a vinyl acetate copolymer, a carboxymethylcellulose, and a polycarbonate, as described, for example, in Japanese Patent Application Laid-Open No. 08-338913 (DESCRIPTION, Paragraph [0022]). A silane coupling agent can be also used as a polymer. As the binder are preferable a water-soluble polymer, such as poly(N-methylolacrylamide), a carboxymethylcellulose, gelatin, a polyvinyl alcohol and a modified polyvinyl alcohol; more preferable gelatin, a polyvinyl alcohol and a modified polyvinyl alcohol; and further preferable a polyvinyl alcohol and a modified polyvinyl alcohol. Particularly preferably, two types of polyvinyl alcohols or modified polyvinyl alcohols different in the degrees of polymerization are used in combination. The degree of saponification of polyvinyl alcohol is preferably 70 to 100%, and more preferably 80 to 100%. The degree of polymerization of a polyvinyl alcohol is preferably 100 to 5,000. The modified polyvinyl alcohol is described in Japanese Patent Application Laid-Open Nos. 08-338913, 09-152509 and 09-316127. Two or more types of polyvinyl alcohols and modified polyvinyl alcohols may be used in combination.

The lower limit of the thickness of the binder is preferably 10 μm. As for the upper limit, the thinner binder is the better in view of light leakage from a liquid crystal display device. Therefore, the binder thickness is preferably equal to or thinner than a polarizer now on the market (about 30 μm), more preferably 25 μm or less, and further preferably 20 μm or less.

The binder of the polarizing membrane may be crosslinked. A polymer or monomer having a crosslinkable functional group may be mixed with the binder, or a crosslinkable functional group may be introduced to the binder polymer. Crosslinking may be initiated by light, heat or pH change to form a binder having a crosslinked structure. Concerning a crosslinking agent, there is a description in the specification of U.S. Reissued Patent No. 23297. Alternatively, a boron compound such as boric acid and borax may be used as a crosslinking agent. The addition amount of a crosslinking agent is preferably 0.1 to 20 mass-% with respect to the binder, so that the orientation of a polarizing element and the wet-heat resistance of the polarizing membrane can be favorable.

After completion of the crosslinking reaction, the unreacted crosslinking agent is preferably 1.0 mass-% or less, and more preferably 0.5 mass-% or less, so that the weather resistance can be improved.

[Stretching of Polarizing Membrane]

A polarizing membrane is preferably stained with iodine or a dichroic dye after stretching (a stretching method) or rubbing (a rubbing method) of the polarizing membrane.

In the stretching method, the stretching ratio is preferably 2.5 to 30.0, and more preferably 3.0 to 10.0. Stretching may be conducted in the air (dry stretching) or dipped in water (wet stretching). The stretching ratio is preferably 2.5 to 5.0 by the dry stretching, and 3.0 to 10.0 by the wet stretching. The stretching may be performed parallel to the machine direction (parallel stretching) or diagonally (diagonal stretching). Such stretching may be performed in a single stage or dividedly in several stages. Stretching conducted in multiple stages is advantageous for a high stretching ration, because the membrane can be stretched still uniformly. More preferable is the diagonal stretching with the tilt angle of 10° to 80°.

(I) Parallel Stretching

Prior to stretching, a PVA film is swollen. The degree of swelling is 1.2 to 2.0 (the mass ratio after swelling to before swelling). Thereafter, the PVA film is transported continuously by means of guide, rolls and the like into a bath containing an aqueous medium or a dyeing bath containing a dichroic dye, in which the PVA film is stretched at a bath temperature of 15 to 50° C., preferably 17 to 40° C. Stretching is conducted by nipping the film by two pairs of nip rolls and by rotating the nip rolls such that the downstream pair of nip rolls transport the film faster than the upstream rolls. The stretching ratio means hereinafter the ratio of (the length after stretching) to (the length before stretching), which is preferably in view of the functional effects mentioned above 1.2 to 3.5, and more preferably 1.5 to 3.0. Thereafter by drying at 50° C. to 90° C. a polarizing membrane can be obtained.

(II) Diagonal Stretching

A diagonal stretching method using a tenter extending in the diagonal direction described in Japanese Patent Application Laid-Open No. 2002-86554 may be applied. According to the method a film is stretched in air, and therefore the film must be treated in advance to contain water ton improve the stretchability. The water content of the film is preferably 5% to 100%. The stretching temperature is preferably 40° C. or higher and 90° C. or lower, and the air humidity during stretching is preferably 50% RH or more and 100% RH or less.

The absorption axis of the polarizing membrane thus obtained is preferably 10° to 80°, more preferably 30° to 60°, and further preferably substantially 45° (40° to 50°).

[Lamination]

A polarizer is prepared by laminating a saponified stretched or unstretched cellulose acylate film and a polarizing layer prepared by stretching. Although there is no particular restriction on direction for lamination, it is preferable to orient the stretching direction of a polarizer at any one of angles 0°, 45° and 90° to the casting direction of the cellulose acylate film.

Although there is no particular restriction on an adhesive to be used for lamination, examples thereof include a PVA resin (including a PVA modified with an acetoacetyl group, a sulfonic acid group, a carboxyl group, and an oxyalkylene group) and an aqueous solution of a boron compound. Among them, a PVA resin is preferable. The thickness of the adhesive layer after drying is preferably 0.01 to 10 μm, and especially preferably 0.05 to 5 μm.

Examples of the structure of the laminate are as below.

a) A/P/A

b) A/P/B

c) A/P/T

d) B/P/B

e) B/P/T

wherein A stands for an unstretched film of the present invention, B for a stretched film of the present invention, T for a cellulose triacylate film (FUJITAC) and P for a polarizing layer. In the structures of a) and b), A and B may be of cellulose acylate of the same or different compositions. In the structures of d), B may be of cellulose acylate of the same or different compositions, as well as with the same or different stretching ratios. Further, if integrated in a liquid crystal display device, either layer may face a liquid crystal layer, however, in case of b) and e) B faces preferably a liquid crystal layer.

In integration into a liquid crystal display device, usually a substrate including a liquid crystal layer is arranged between two polarizers. In this case, a) to e) of the present invention and a conventional polarizer (T/P/T) may be freely combined for use. It is preferable, however, on the outermost film on the display of the liquid crystal display device to construct a transparent hard coat layer, an antiglare layer, an antireflection layer, etc. and those described hereinbelow may be used.

The higher light transmittance of the thus obtained polarizer is the more preferable, and the higher degree of polarization is the more preferable. The light transmittance of the polarizer at a wavelength of 550 nm is preferably in the range of 30 to 50%, more preferably in the range of 35 to 50%, and further preferably in the range of 40 to 50%. The degree of polarization for light with a wavelength of 550 nm is preferably in the range of 90 to 100%, more preferably 95 to 100%, and most preferably, 99 to 100%.

By laminating the polarizer thus obtained with a λ/4 plate, circular polarization can be obtained. In this case, the two are laminated such that the slow axis of the λ/4 plate and the absorption axis of the polarizer contain an angle of 45°. Thereby, there is no particular restriction on the λ/4 plate, a λ/4 plate having such wavelength-dependent retardation is preferable, that the retardation decreases as the wavelength decreases. Furthermore, a polarizing membrane having an absorption axis tilted by 20° to 70° relative to the longitudinal direction, and a λ/4 plate composed of an optically anisotropic layer composed of a liquid crystalline compound are preferably used.

A protective film may be bonded to one of the surfaces of the polarizer, and a separation film to the other surface. The protective film and the separation film are used in order to protect the polarizer when it is shipped or inspected, for example.

(ii) Formation of Optical Compensation Film

It is also preferable to combine a optical compensation film and a polarizing is formed. More specifically, a coating solution for the optically anisotropic layer is applied onto the surface of the polarizing layer to form an optically anisotropic layer. As a result, since a polymer film is not used between the polarizing layer and the optically anisotropic layer, a thin-thickness polarizer with reduced stress (strain×cross-section×elastic modulus) to be generated by dimensional change of the polarizing layer is formed. Integrating the polarizer of the present invention into a large-size liquid crystal display device, the image of high display quality without the problem of light leakage can be obtained.

Stretching is preferably so conducted that the tilt angle between the polarizing layer and the optical compensation layer should conform with the angle between transmission axes of two polarizers, which are adhered to both sides of a liquid crystal cell constituting an LCD, and the longitudinal or transverse direction of the liquid crystal cell. The tilt angle is generally 45°. However, transmission type, reflection type and semi-transmission type LCD devices with the tilt angle other than 45° have been developed recently. Consequently, it is preferable that the stretching direction can be adjusted flexibly in accordance with the design of an LCD.

[Liquid Crystal Display Device]

Various liquid crystal modes using such optical compensation film will be explained below.

(TN Mode Liquid Crystal Display Device)

The TN mode liquid crystal display device is most frequently used as a color TFT liquid crystal display device, and described in many documents. In the orientation state of a liquid crystal cell of the TN mode at black display, rod-like liquid crystalline molecules rise in the middle of the cell, whereas rod-like liquid crystalline molecules are in the lying orientation state near the cell substrate.

(OCB Mode-liquid Crystal Display Device)

This uses a liquid crystal cell of a bend orientation mode, in which rod-like liquid crystalline molecules are oriented in substantially reverse directions (symmetrically) at the upper part and lower part of the liquid crystal cell. A liquid crystal display device using a bend orientation mode liquid crystal cell is disclosed in the specifications of U.S. Pat. Nos. 4,583,825 and 5,410,422. Since the rod-like liquid crystalline molecules are oriented symmetrically at the upper and lower parts of the liquid crystal cell, the bend orientation mode liquid crystal cell has a self-optical-compensation function. Consequently, this liquid crystal mode is also referred to called as the OCB (optically compensatory bend) liquid crystal mode.

In the OCB mode liquid crystal cell, as in the case of the TN mode, in case of the orientation state for black display, rod-like liquid crystalline molecules rise in the center of the cell, whereas they are in the lying orientation state near the cell substrate.

(VA Mode Liquid Crystal Display Device)

The VA mode liquid crystal display device is characterized in that rod-like liquid crystalline molecules are oriented substantially vertically when no voltage is applied. Examples of the VA mode liquid crystal cell include (1) a VA mode liquid crystal cell in a narrow sense, in which rod-like liquid crystalline molecules are oriented substantially vertically without voltage application, and orient substantially horizontally with voltage application (described in Japanese Patent Application Laid-Open No. 02-176625); (2) an MVA mode liquid crystal cell, in which the VA mode is divided into multi-domains in order to enlarge the viewing angle (described in Proceeding of SID97, Digest of Tech. Papers 28 (1997), 845); (3) an n-ASM mode liquid crystal cell, in which rod-like liquid crystalline molecules are oriented substantially vertically without voltage application, and turned to twisted multi-domain orientation with voltage application (Proceeding of Japanese liquid crystal symposium (1998), p. 58-59); and (4) a SURVAIVAL mode liquid crystal cell (publicated in LCD International '98).

(IPS Mode Liquid Crystal Display Device)

The IPS mode liquid crystal display device is characterized in that rod-like liquid crystalline molecules are oriented substantially horizontally in a plane without voltage application. The orientation of the liquid crystalline molecules is changed by voltage application functioning as a switch. Specific usable examples thereof are described in Japanese Patent Application Laid-Open Nos. 2004-365941, 2004-12731, 2004-215620, 2002-221726, 2002-55341 and 2003-195333.

(Other Liquid Crystal Display Devices)

Optical compensation can be performed according to a similar concept as above for the ECB and STN (Supper Twisted Nematic) mode, the FLC (Ferroelectric Liquid Crystal) mode, the AFLC (Anti-ferroelectric Liquid Crystal) mode, and the ASM (Axially Symmetric Aligned Microcell) mode. Furthermore, the cells can be applicable to liquid crystal display devices of any of a transmission type, a reflective type and a semi-transmission type. The same can be also favorably utilized as an optical compensation sheet for a reflective type liquid crystal display device of GH (Guest-Host) type.

These uses of the cellulose derivative film mentioned above are described in details in Technical Report No. 2001-1745, published on 15 Mar. 2001 by the Japan Institution of Invention and Innovation, p. 45 to 59.

Formation of Anti-reflective Layer (Anti-reflective Film)

The anti-reflective film is generally constructed by forming a low refractive index layer, serving also as an antifouling layer, and at least one layer having a higher refractive index than that of the low refractive index layer (i.e. a high refractive index layer or a medium refractive index layer) on a transparent substrate.

An example of a method for forming the anti-reflective film is to form a multi-layered film by laminating transparent membranes of inorganic compounds (e.g. metal oxides) having different refractive indices, and form thereon a coat layer of colloidal metal oxide particles by a chemical vapor deposition (CVD) method, a physical vapor deposition (PVD) method, or a sol-gel technique from a metal compound such as a metal alkoxide, which is then subjected to an aftertreatment (UV ray irradiation: Japanese Patent Application Laid-Open No. 09-157855; and plasma treatment: Japanese Patent Application Laid-Open No. 2002-327310).

On the other hand, as anti-reflective films having a high productivity, various types of anti-reflective films have been proposed, which are formed by coating multi-layers containing inorganic particles dispersed in the matrix.

There is an anti-reflective film comprising an anti-reflective layer having an anti-glare property, which is conferred by minute roughening of the top surface of the anti-reflective film formed by coating as above.

A cellulose acylate film of the present invention is applicable to any of the above methods, but the coating method (coating type) is especially preferable.

[Layer Structure of Coating Type Anti-reflective Film]

The anti-reflective film having the layer structure constituted at least of a medium refractive index layer, a high refractive index layer and a low refractive index layer (outermost layer) on a substrate in the mentioned order should be designed to have refractive indices satisfying the following relationships.

The refractive index of the high refractive index layer>the refractive index of the medium refractive index layer>the refractive index of the transparent substrate>the refractive index of the low refractive index layer. Furthermore, a hard-coat layer may be provided between the transparent substrate and the medium refractive index layer.

The anti-reflective film may be constituted of a medium refractive index hard coat layer, a high refractive index layer and a low refractive index layer.

Examples thereof are described in Japanese Patent Application Laid-Open Nos. 08-122504, 08-110401, 10-300902, 2002-243906 and 2000-111706. Furthermore, other function may be added to each of the layers. For example, a low refractive index layer having an anti-fouling function, and a high refractive index layer having an anti-static function may be exemplified (e.g., Japanese Patent Application Laid-Open Nos. 10-206603 and 2002-243906).

The haze of the anti-reflective film is preferably 5% or less, and more preferably 3% or less. The strength of the film is preferably “H” or harder based on the pencil hardness test according to JIS K5400, more preferably “2H” or harder, and further preferably, “3H” or harder.

[High Refractive Index Layer and Medium Refractive Index Layer]

The high refractive index layer of the anti-reflective film is constituted of a curable film containing at least ultra-fine inorganic particles with the average particle size of 100 nm or less and a high refractive index and a matrix binder.

As the ultra-fine inorganic particles with a high refractive index, there are exemplified inorganic compounds having a refractive index of 1.65 or higher, and preferably those having a refractive index of 1.9 or higher. Examples thereof include oxides of Ti, Zn, Sb, Sn, Zr, Ce, Ta, La and In, and composite oxides containing these metal atoms.

Such ultra-fine particles are prepared for example by: treating the particle surface by a surface treatment agent (e.g. by a silane coupling agents: Japanese Patent Application Laid-Open Nos. 11-295503, 11-153703, and 2000-9908; by an anionic compound or an organo-metal coupling agent: Japanese Patent Application Laid-Open No. 2001-310432); forming a core-shell structure with a high refractive index particle as a core (e.g. Japanese Patent Application Laid-Open No. 2001-166104); and using a specific dispersion agent in combination (e.g. Japanese Patent Application Laid-Open Nos. 11-153703 and 2002-2776069, and U.S. Pat. No. 6,210,858 B1).

As a material for forming a matrix, a thermoplastic resin and a thermosetting resin film known publicly can be exemplified.

Furthermore, as a material for a matrix, at least one composition selected from a composition containing a multifunctional compound with at least 2 radical and/or cationic polymerizable groups, a composition containing an organo-metallic compound with a hydrolysable group and partial condensation products thereof is preferable. Examples thereof include the compounds described in Japanese Patent Application Laid-Open Nos. 2000-47004, 2001-315242, 2001-31871, and 2001-296401.

Furthermore, a curable film obtained from a colloidal metal oxide, which is obtained from a hydrolytic condensation product of a metal alkoxide, and a metal alkoxide composition is also a preferable material. Such a material is described for example in Japanese Patent Application Laid-Open No. 2001-293818.

The refractive index of the high refractive index layer is generally 1.70 to 2.20. The thickness of the high refractive index layer is preferably 5 nm to 10 μm, and more preferably 10 nm to 1 μm.

The refractive index of the medium refractive index layer is adjusted so as to fall between the refractive indices of the low refractive index layer and the high refractive index layer. The refractive index of the medium refractive index layer is preferably 1.50 to 1.70.

[Low Refractive Index Layer]

The low refractive index layer is formed sequentially by lamination on the high refractive index layer. The refractive index of the low refractive index layer is 1.20 to 1.55, and preferably 1.30 to 1.50.

The low refractive index layer is preferably formed as the outermost layer having anti-scratch property and anti-fouling property. To improve substantially the anti-scratch property, it is effective to confer a slipping property to the surface, which can be realized by a publicly known means, such as introduction of silicone or fluorine into a film.

The refractive index of a fluorine-containing compound is preferably 1.35 to 1.50, and more preferably 1.36 to 1.47. The fluorine-containing compound is preferably a compound containing a fluorine atom in the range of 35 to 80 mass-% and additionally a crosslinkable or polymerizable functional group.

Examples of the fluorine-containing compound are described for example in Japanese Patent Application Laid-Open Nos. 09-222503 (DESCRIPTION, paragraphs to [0026]), 11-38202 (DESCRIPTION, paragraphs [0019] to [0030]), 2001-40284 (DESCRIPTION, paragraphs [0027] to [0028]) and 2000-284102.

As a silicone compound, a compound which has a polysiloxane structure, having in its polymer chain a curable or polymerizable functional group, and forms a crosslinked structure in the film is preferable. Examples thereof include a reactive silicone (e.g. Silaplane (trade name), Chisso Corporation) and a polysiloxane having silanol groups at both the ends (Japanese Patent Application Laid-Open No. 11-258403).

The crosslinking or polymerization reaction of a fluorine containing polymer and/or a siloxane polymer, having crosslinkable or polymerizable groups is preferably conducted by light irradiation or heating, simultaneously with or after the application of a coating composition for forming the outermost layer, containing a polymerization initiator or a sensitizer.

As the low refractive index layer, a sol-gel curable film is also preferable, which is cured in the presence of a catalyst by the condensation reaction between an organo-metallic compound, such as a silane coupling agent, and a silane coupling agent containing a certain fluorine-containing hydrocarbon group.

Examples of such compound include a silane compound containing a polyfluoroalkyl group or partial hydrolytic condensation products thereof (described in Japanese Patent Application Laid-Open Nos. 58-142958, 58-147483, 58-147484, 09-157582, and 11-106704), and a silyl compound containing a polyperfluoroalkyl ether group, which is a fluorine-containing long-chain group (described in Japanese Patent Application Laid-Open Nos. 2000-117902, 2001-48590, and 2002-53804).

The low refractive index layer may contain, in addition to the aforementioned additives, a filler, such as a low refractive index inorganic compound whose average primary particle size is 1 to 150 nm (e.g. a silicon dioxide (silica) and fluorine-containing particles (magnesium fluoride, calcium fluoride and barium fluoride), and organic fine particles described in Japanese Patent Application Laid-Open No. 11-3820, DESCRIPTION, paragraphs [0020] to [0038]); a silane coupling agent; a slipping agent; a surfactant, and the like.

In case the low refractive index layer is formed underneath the outermost layer, the low refractive index layer may be formed by a vapor phase method, such as a vacuum deposition method, a sputtering method, an ion plating method, and a plasma CVD method. In view of the low production cost, a coating method is preferable.

The thickness of the low refractive index layer is preferably 30 to 200 nm, more preferably 50 to 150 nm, and further preferably 60 to 120 nm.

[Hard Coat Layer]

A hard coat layer is provided on the surface of a stretched or unstretched cellulose acylate film to confer physical strength to the anti-reflective film. In particular, the hard coat layer is preferably provided between the stretched or unstretched cellulose acylate film and the high refractive index layer. It is also preferable to coat the hard coat directly on the stretched or unstretched cellulose acylate film without providing the anti-reflective layer.

The hard coat layer is preferably formed by a crosslinking reaction or a polymerization reaction of a photo- and/or thermocuring compound. As a curing functional group, a photo-polymerizable functional group is preferable. Furthermore, as an organometallic compound containing a hydrolysable functional group, an organic alkoxysilyl compound is preferable.

Specific examples of these compounds include those exemplified for the high refractive index layer.

Specific examples of compositions for the hard coat layer are described in Japanese Patent Application Laid-Open Nos. 2002-144913 and 2000-9908, and International Publication No. WO00/46617.

The high refractive index layer can function as a hard coat layer as well. In this case, the layer is preferably formed by dispersing fine particles finely in the hard coat layer according to the technique described for the high refractive index layer.

The hard coat layer can function also as an anti-glare layer (described hereinbelow) by adding particles with the average particle size of 0.2 to 10 μm to confer the anti-glare function.

The thickness of the hard coat layer may be appropriately designed depending on the use. The thickness of the hard coat layer is preferably 0.2 to 10 μm, and more preferably 0.5 to 7 μm.

The strength of the hard coat layer is preferably “H” or harder based on the pencil hardness test according to JIS K5400, more preferably “2H” or harder, and further preferably “3H” or harder. Also, the abrasion of a specimen through a Taber abrasion test according to JIS K5400 should be preferably as low as possible.

[Front Scattering Layer]

The front scatting layer works, when mounted to a liquid crystal display device, to confer the viewing angle improving effect for cases the viewing angle is tilted variously (up and down, right and left). A hard coat layer can serve as a front scatting layer, if fine particles having different refractive indices are dispersed in the hard coat layer.

Examples thereof include those specifying the front scatting coefficient described in Japanese Patent Application Laid-Open No. 11-38208, those specifying the range of the relative refractive indices of a transparent resin and fine particles described in Japanese Patent Application Laid-Open No. 2000-199809, and those specifying the haze at 40% or higher described in Japanese Patent Application Laid-Open No. 2002-107512.

[Other Layers]

In addition to the aforementioned layers, a primer layer, an antistatic layer, an undercoating layer, and a protective layer may be provided.

[Coating Method]

Individual layers of the anti-reflective film may be formed by a coating method, such as a dip-coating method, an air-knife coating method, a curtain coating method, a roll coating method, a wire-bar coating method, a gravure coating method, a micro-gravure coating method and an extrusion coating method (U.S. Pat. No. 2,681,294).

[Anti-glare Function]

The anti-reflective film may have an anti-glare function to scatter the external light. The anti-glare function can be attained by forming concavities and convexities on the surface of the anti-reflective film. In case the anti-reflective film has an anti-glare function, the haze of the anti-reflective film is preferably 3 to 30%, more preferably 5 to 20%, and further preferably 7 to 20%.

As a method of forming concavities and convexities on the surface of the anti-reflective film, any method may be used insofar as it can sufficiently maintain such surface profile. Examples thereof include a method to add fine particles to the low refractive index layer to form concavities and convexities on a film surface (e.g. Japanese Patent Application Laid-Open No. 2000-271878); a method to add a small amount (0.1 to 50 mass-%) of relatively large particles (particle size of 0.05 to 2 μm) in the underlying layer of the low refractive index layer (i.e. a high refractive index layer, a medium refractive index layer or a hard coat layer) to create a underlying layer having concavities and convexities on its surface, and to add the low refractive index layer thereon with maintaining the concavities and convexities (e.g., Japanese Patent Application Laid-Open Nos. 2000-281410, 2000-95893, 2001-100004 and 2001-281407); and a method to transfer ruggedness physically onto the coated surface of the uppermost layer (an anti-fouling layer) by, for example, embossing (Japanese Patent Application Laid-Open Nos. 63-278839, 11-183710 and 2000-275401).

[Use]

The unstretched or stretched cellulose acylate film of the present invention is useful as an optical film, in particular, a protective film for a polarizer, an optical compensation sheet (AKA retardation film) for a liquid crystal display device, an optical compensation sheet for a reflective liquid crystal display device, and a substrate for a silver halide photographic photosensitive material.

The measuring methods used in the present invention will be described below.

(1) Wet Heat Dimensional Change (δL(w))

1) Film samples are cut out of a film in the MD as well as TD directions, preconditioned at 25° C. in 60% RH for 5 hours or longer, and then the lengths thereof are measured by a “pin gauge” with the 20 cm-base length as MD(F) and TD(F) respectively.

2) The samples are left standing without tension in a thermo-hygrostat at 60° C. in 90% RH for 500 hours (heat treatment).

3) After taken out of the thermo-hygrostat, the samples are humidity-conditioned at 25° C. in 60% RH for 5 hours or longer, and then the lengths thereof are measured by the “pin gauge” with the 20 cm-base length as MD(t) and TD(t) respectively.

4) The wet heat dimensional changes in MD and TD directions (δMD(w) and δTD(w)) are determined according to the following formulas, and the larger value is taken as the wet heat dimensional change (δL(w)).

δTD(w)(%)=100×|TD(F)−TD(t)|/TD(F)

δMD(w)(%)=100×|MD(F)−MD(t)|/MD(F)

(4) Dry Heat Dimensional Change (δL(d))

Except that the heat treatment of the wet heat dimensional change test is changed to at 80° C. in a dry atmosphere for 500 hours, the dry heat dimensional change is determined identically.

(3) Re, Rth

Film samples are humidity-conditioned at 25° C. in 60% RH for 5 hours or longer. Retardations at the wave length of 550 nm perpendicular to the surface of the film sample, and tilted by ±40° from the normal to the film surface are measured at 25° C. in 60% RH by an automatic birefringence analyzer (KOBRA 21 ADH by Oji Scientific Instruments). The in-plane retardation (Re) is calculated from the perpendicular measurement, and the thickness-direction retardation (Rth) is calculated from the perpendicular and ±40° direction measurements. They are taken as Re and Rth.

(4) Wet Heat Change of Re, Rth

1) Film samples are humidity-conditioned at 25° C. in 60% RH for 5 hours or longer, and then Re and Rth are measured according to the above method to obtain Re(f) and Rth(f) respectively.

2) The samples are left standing without tension in a thermo-hygrostat at 60° C. in 90% RH for 500 hours (heat treatment).

3) After taken out of the thermo-hygrostat, the samples are humidity-conditioned at 25° C. in 60% RH for 5 hours or longer, and then Re and Rth are measured according to the above method to obtain Re(t) and Rth(t) respectively.

4) The wet heat changes of Re and Rth are determined according to the following formulas.

Wet heat change of Re(%)=100×(Re(f)−Re(t))/Re(f)

Wet heat change of Rth(%)=100×(Rth(f)−Rth(t))/Rth(f)

(5) Dry heat change of Re, Rth Except that the heat treatment of the wet heat change test of Re and Rth is changed to at 80° C. in a dry atmosphere for 500 hours, the dry heat change is determined identically.

(6) Minute Unevenness of Retardation

The samples are humidity-conditioned at 25° C. in 60% RH for 5 hours or longer, and then Re is measured shifting with a pitch of 0.1 mm in the MD direction by an ellipsometer (Automatic Birefringence Tester ABR-10A-10AT by Uniopt Corporation, Ltd.). Then the value of the minute unevenness of retardation in the MD direction is determined as the quotient of the difference of the maximum value and minimum value divided by the mean value of 10 measurements.

Re is measured also in the TD direction similarly shifting with a pitch of 0.1 mm, and the value of the minute unevenness of retardation in the TD direction is determined.

The larger of the values of the minute unevenness of retardation in the MD direction and in the TD direction is taken as the value of the minute unevenness of retardation.

(7) Length/width Ratio

The ratio (L/W) of the distance between nip rolls used for stretching (L: distance between the axes of 2 pairs of nip rolls) to the cellulose acylate film width (W) before stretching. In case 3 or more pairs of nip rolls are used, the largest L/W value is taken as the length/width ratio.

(8) Relaxation Ratio

This means the quotient of the relaxed length divided by the length before stretching, expressed in percentage.

(9) Substitution Degree of Cellulose Acylate

The substitution degree of cellulose acylate is determined by ¹³C-NMR according to the method of Tezuka, et al. Carbonhydr. Res., 273 (1995) 83-91.

The features of the present invention will be described in more detail by means of Examples and Comparative Examples, provided that the materials, quantities used, contents, treatments, procedures, etc. described in Examples may be freely changed without departing from the spirit of the present invention. Consequently, the scope of the present invention should not be interpreted in any restrictive way by reason of the following Examples.

### EXAMPLES

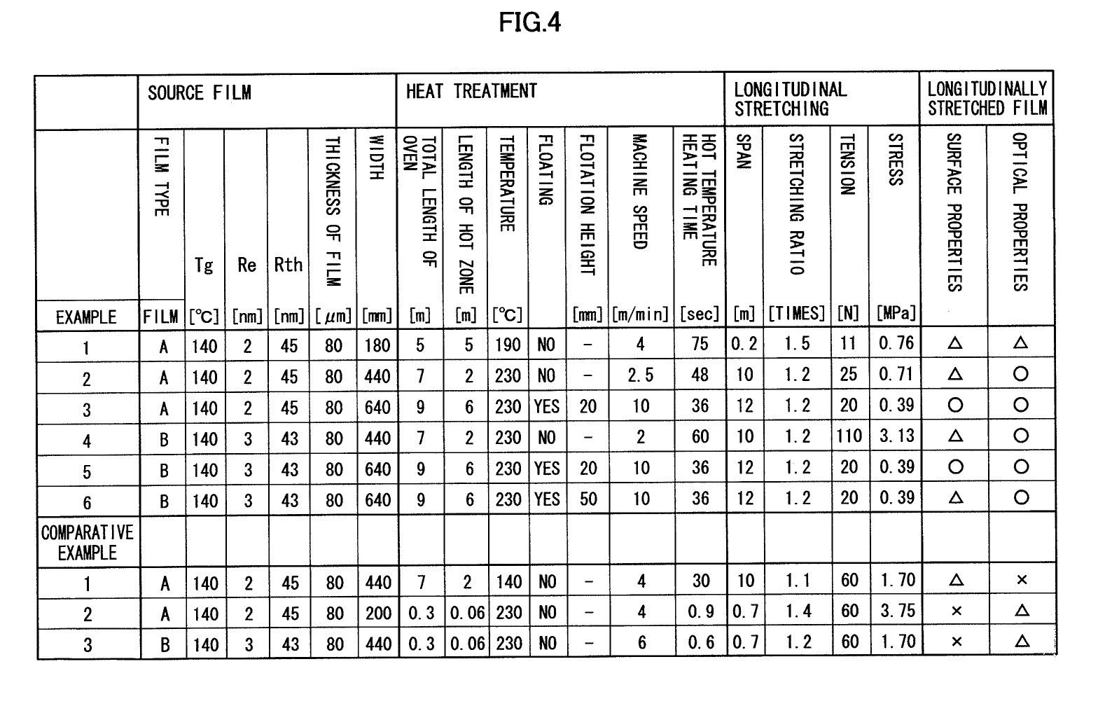

Commercially available film A (FUJITAC T80UZ by Fuji Photo Film Co.) and film B (FUJITAC TD80UF by Fuji Photo Film Co.) were used as sources for longitudinal film stretching tests. The physical properties of the source films (Tg, Re, Rth, thickness and source film width) are described in the table of FIG. 4.

The source films were heated under the heating conditions described in the table (total length of the heating oven, length of the hot zone and temperature thereof, existence of flotation means of the film and (if existing) flotation height, machine speed, and high temperature heating time), and simultaneously longitudinally stretched under the longitudinally stretching conditions described in the table (distance between the rolls (span), stretching ratio, and tension and stress on the film). Meanwhile, the temperature of the heat treatment in the table 1 shows the set temperature of the heating oven, and therefore the actual film temperature may become lower than the set temperature of the heating oven by about 10° C. due to a time lag in temperature increase or an influence of heat efficiency.

The respective films obtained under these conditions were evaluated. The results are shown in the table of FIG. 4. The evaluations of the films were conducted with respect to the surface properties and optical properties according to the following criteria.

(Surface Properties)

The surface properties were evaluated by visual observation of the surface of the obtained film surface, and according to the following rating scale.

◯: Good film surface, and suitable for an optical film;
Δ: Wrinkle or scratch appearing slightly on the film surface, but applicable for an optical film; and
X: Obvious wrinkles or scratchs over the film surface, and not applicable for an optical film.

(Optical Properties)

◯: Highly developed retardation Re, Rth, and highly characteristic as an optical film;
Δ: Moderately developed retardation Re, Rth, and moderately characteristic as an optical film; and
X: Weakly developed retardation Re, Rth, and not characteristic as an optical film.

As obvious from the table of FIG. 4, by conducting the longitudinally stretching methods of Examples 1 to 6 according to the present invention, Δ to ◯ ratings can be obtained concerning the surface properties and the optical properties, which indicated that the retardation could be well regulated and uniform films can be produced. In contrast, in Comparative Examples 1 to 3, where the conditions (high temperature heating time and temperature of the hot zone of the heating oven) were not in the range according to the present invention, the evaluations concerning the surface properties and the optical properties gave the ratings of Δ to X, and the film with the desired retardation could not be produced. In Example 1 the longitudinally stretching span was shorter than the total length of the heating oven, because the equipment having stretching rolls in the high temperature zone inside the heating oven was used for longitudinal stretching. It becomes clear from Examples 5 and 6, that, when the film is floated and conveyed in the heating oven, the surface property rating is better, if the flotation height is within 30 mm.

1. A method for longitudinally stretching a thermoplastic resin film by drawing the thermoplastic resin with a pair of rolls rotating at different circumferential velocities, the method comprising:
setting a temperature inside a heating oven installed between the pair of rolls at Tg of the thermoplastic resin film+50° C. or higher and Tg+140° C. or lower; and
stretching the thermoplastic resin film in the heating oven over a heating time of 1 sec or longer and 100 sec or shorter.

2. The method for longitudinally stretching a thermoplastic resin film according to claim 1, wherein
a distance between the rolls is 1 m or more and 100 m or less.

3. The method for longitudinally stretching a thermoplastic resin film according to claim 1, wherein
a stress of the thermoplastic resin film between the rolls is set in a range from 0.4 MPa or more to 8 MPa or less.

4. The method for longitudinally stretching a thermoplastic resin film according to claim 1, wherein
conveying rolls are not installed inside the heating oven.

5. The method for longitudinally stretching a thermoplastic resin film according to claim 4, wherein
the thermoplastic resin film is floated and conveyed in the heating oven.

6. The method for longitudinally stretching a thermoplastic resin film according to claim 5, wherein
the flotation is carried out by an air pressure blown out of nozzles provided above and beneath the thermoplastic resin film.

7. The method for longitudinally stretching a thermoplastic resin film according to claim 6, wherein
the flotation height is within 30 mm.

8. The method for longitudinally stretching a thermoplastic resin film according to claim 1, wherein
the longitudinal stretching ratio of the film is more than 1.0 and 2.0 or less.

9. A longitudinally stretched film, characterized by being produced by the method for longitudinally stretching a thermoplastic resin film according to claim 1.

10. The longitudinally stretched film according to claim 9, wherein the
thermoplastic resin is a cellulose acylate resin.

11. The method for longitudinally stretching a thermoplastic resin film according to claim 2, wherein
a stress of the thermoplastic resin film between the rolls is set in a range from 0.4 MPa or more to 8 MPa or less.

12. The method for longitudinally stretching a thermoplastic resin film according to claim 2, wherein
conveying rolls are not installed inside the heating oven.

13. The method for longitudinally stretching a thermoplastic resin film according to claim 2, wherein
the longitudinal stretching ratio of the film is more than 1.0 and 2.0 or less.

14. The method for longitudinally stretching a thermoplastic resin film according to claim 3, wherein
conveying rolls are not installed inside the heating oven.

15. The method for longitudinally stretching a thermoplastic resin film according to claim 3, wherein
the longitudinal stretching ratio of the film is more than 1.0 and 2.0 or less.

16. A longitudinally stretched film, characterized by being produced by the method for longitudinally stretching a thermoplastic resin film according to claim 2.

17. A longitudinally stretched film, characterized by being produced by the method for longitudinally stretching a thermoplastic resin film according to claim 3.
